(19) United States
(12) Patent Application Publication
(10) Pub. No.: US 2011/0217985 A1
(43) Pub. Date: Sep. 8, 2011

(54) PREDICTIVE SHORT-TERM CHANNEL QUALITY REPORTING UTILIZING REFERENCE SIGNALS

(75) Inventor: Alexei Yurievitch Gorokhov, San Diego, CA (US)

(73) Assignee: QUALCOMM INCORPORATED, San Diego, CA (US)

(21) Appl. No.: 12/876,400

(22) Filed: Sep. 7, 2010

Related U.S. Application Data
(60) Provisional application No. 61/246,475, filed on Sep. 28, 2009.

(51) Int. Cl. H04W 72/08

(52) U.S. Cl. 455/452.2

(57) ABSTRACT

Providing for resource-specific interference reporting to facilitate short-term channel quality and transmission parameterization in wireless communications is provided herein. By way of example, a UE observing high interference can utilize reference signals of a second UE (e.g., that observes less interference) for short-term channel quality measurements. These measurements can be on an order of one or two signal subframes, or less, to reflect interference resulting from distinct scheduling decisions of an interfering transmitter. Based on the short-term channel quality measurements, a base station serving the UE can initiate detailed interference mitigation, perform scheduling decisions that compensate for distinct parameterization of the interfering cell, or the like. This can result in improved wireless communications even for UEs observing very high wireless interference.

### CLAIM OF PRIORITY UNDER 35 U.S.C §119

The present application for patent claims priority to Provisional Patent Application Ser. No. 61/246,475 entitled “PREDICTIVE SHORT-TERM CHANNEL QUALITY REPORTING BASED ON DEMODULATION REFERENCE SIGNALS” and filed Sep. 28, 2009, assigned to the assignee hereof and hereby expressly incorporated by reference herein.

### BACKGROUND

I. Field

The following description relates generally to wireless communications, and more particularly to facilitating wireless communication for terminals observing significant wireless interference.

II. Background

Wireless communication systems are widely deployed to provide various types of communication content, such as voice content, data content, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), or multi-carrier wireless specifications such as evolution data optimized (EV-DO), one or more revisions thereof, etc.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

To supplement conventional mobile phone network base stations, additional base stations may be deployed to provide more robust wireless coverage to mobile units. For example, wireless relay stations and small-coverage base stations (e.g., commonly referred to as access point base stations, Home NodeBs, Femto access points, or Femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

One important aspect of mobile communication technology is managing interference among transmitters. A typical cell of a cellular phone site, for instance, can often employ multiple transceiver units to communicate with user terminals within the cell. Transmission area of various transceiver units typically overlap, such that a single mobile unit often obtains several overlapping signals at a given point in time. Furthermore, transmitters within neighboring cells can transmit signals that reach these user terminals, causing inter-cell interference as well. Accordingly, signal interference is common in many wireless communication systems, potentially reducing signal clarity and cell communication quality if left uncorrected.

Because interference degrades communication quality, mechanisms exist for reducing intra-site and inter-site interference. Some involve utilizing MISO and MIMO transceivers that can tolerate higher levels of interference, due to improved signal analysis at the receiver. Newer modulation techniques, such as orthogonal multi-carrier modulation (e.g., as utilized with orthogonal frequency division multiplexing [OFDM]), can effectively reduce signal interference. OFDM employs orthogonal sub-carrier frequencies to reduce or eliminate cross-talk interference among carrier signals. Another technique includes negotiating priority on shared channel resources within a cell. If transmission power of an interferer is maintained within an acceptable range, overlapping signals on a channel resource can often be tolerated at a receiver.

Mobile communication systems are in constant state of flux, however, as new research and technologies are discovered. Architectural changes in mobile technology are implemented to increase data rates, bandwidth, or to progress to all-data communications. The interference problem typically must be re-visited for each new technology, to determine whether the balance provided by previous interference management mechanisms will be disturbed. Thus, signal interference management is an ongoing problem, requiring new solutions as new mobile communications technologies are implemented.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the subject disclosure in a simplified form as a prelude to the more detailed description that is presented later.

The subject disclosure provides for short-term interference reporting to facilitate short-term channel quality and transmission parameterization in wireless communications. According to some aspects of the subject disclosure, a user equipment (a UE) observing high interference can utilize reference signals of a second UE (e.g., that observes less interference) for short-term channel quality measurements. In at least one aspect, short-term channel quality measurements can be on an order of one or two signal subframes, subslots, or the like, or even less. Channel measurements at this granularity can reflect interference resulting from distinct transmit power decisions, power spectral density parameters, spatial beam parameters, etc., of an interfering transmitter. Based on the short-term channel quality measurements, a base station serving the UE can initiate detailed interference mitigation, perform scheduling decisions that compensate for distinct parameterization of the interfering cell, or the like. This can result in improved wireless communications even for UEs observing very high wireless interference.

In other disclosed aspects, provided is a method for wireless communication. The method can comprise scheduling a data transmission for a first user equipment (a first UE) served by a cell of a wireless network on a set of time-frequency resources. Moreover, the method can comprise transmitting a reference signal (a RS) configured at least in part for facilitating reception of the data transmission by the first UE. Additionally, the method can comprise instructing a second UE served by the cell to measure the RS and acquire a resource-specific metric of communication link quality for the set of time-frequency resources.

In further aspects, provided is an apparatus for wireless communication. The apparatus can comprise a memory for storing instructions configured to provide scheduling efficiency for interference mitigation for wireless communication and a processor that executes modules for implementing the instructions. Particularly, the modules can include an interference mitigation module that identifies a data transmission scheduled for a first user equipment (a first UE) served by the apparatus and that prepares a wireless message instructing a second UE to measure interference to a pilot signal on a set of wireless resources specified in the wireless message; wherein the pilot signal is configured at least in part for receiving the data transmission. The modules can also include a transmission module that sends the wireless message to the second UE.

In other aspects, disclosed is an apparatus for wireless communication. The apparatus can comprise means for scheduling a data transmission for a first user equipment (a first UE) served by a cell of a wireless network on a set of time-frequency resources. In addition, the apparatus can comprise means for transmitting a reference signal (a RS) configured at least in part for facilitating reception of the data transmission by the first UE. Further to the above, the apparatus can comprise means for instructing a second UE served by the cell to measure the RS and acquire a resource-specific metric of communication link quality for the set of time-frequency resources.

According to one or more additional aspects, disclosed is at least one processor configured for wireless communication. The processor(s) can comprise a first module that schedules a data transmission for a first user equipment (a first UE) served by a cell of a wireless network on a set of time-frequency resources. The processor(s) can also comprise a second module that transmits a reference signal (a RS) configured at least in part for facilitating reception of the data transmission by the first UE. Furthermore, the processor(s) can comprise a third module that instructs a second UE served by the cell to measure the RS and acquire a resource-specific metric of communication link quality for the set of time-frequency resources.

In another aspect, the subject disclosure provides a computer program product comprising a computer-readable medium. The computer-readable medium can comprise a first set of codes for causing a computer to schedule a data transmission for a first user equipment (a first UE) served by a cell of a wireless network on a set of time-frequency resources. In addition, the computer-readable medium can comprise a second set of codes for causing the computer to transmit a reference signal (a RS) configured at least in part for facilitating reception of the data transmission by the first UE. Further to the above, the computer-readable medium can comprise a third set of codes for causing the computer to send an instruction to a second UE served by the cell to measure the RS and acquire a resource-specific metric of communication link quality for the set of time-frequency resources.

In still other disclosed aspect, provided is a method for wireless communication. The method can comprise receiving a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE. Additionally, the method can comprise measuring a level of interference to the UE-RS observed by the UE on the subset of time-frequency resources.

According to one or more additional aspects, the subject disclosure provides an apparatus configured for wireless communication. The apparatus can comprise a memory for storing instructions configured to provide short-term resource-specific interference reporting for wireless communication and a data processor for executing modules to implement the instructions. Particularly, the modules can comprise a decoding module that identifies a wireless message within a downlink transmission instructing a user equipment (a UE) associated with the apparatus to measure resource-specific interference to a pilot signal transmitted by a serving cell. The modules can further comprise an analysis module that acquires information for identifying and decoding the pilot signal from the wireless message, and measures the resource-specific interference to the pilot signal with a time-based precision of substantially one subframe.

Other aspects of the subject disclosure provide an apparatus for wireless communication. The apparatus can comprise means for receiving a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE. Moreover, the apparatus can comprise means for measuring a level of interference to the UE-RS observed by the UE on the subset of time-frequency resources.

Still other aspects disclose at least one processor configured for wireless communication. The processor(s) can comprise a first module that receives a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE. Further, the processor(s) can comprise a second module that measures a level of interference to the UE-RS observed by the UE on the subset of time-frequency resources.

Additional aspects provide a computer program product comprising a computer-readable medium. The computer-readable medium can comprise a first set of codes for causing a computer to receive a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE. In addition, the computer-readable medium can comprise a second set of codes for causing the computer to measure a level of interference to the UE-RS observed by the UE on the subset of time-frequency resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 depicts a block diagram of an example wireless communication environment to mitigate interference according to aspects of the subject disclosure.

FIG. 2 illustrates example wireless communication diagrams for measuring and reporting short-term interference in wireless communications.

FIG. 3 illustrates a sample wireless communication diagram for employing a demodulation reference signal (DM-RS) for interference mitigation.

FIG. 4 depicts a block diagram of example wireless resources for use with short-term interference reporting according to further disclosed aspects.

FIG. 5 depicts a block diagram of an example timing diagram for short-term channel measurement and reporting according to additional aspects.

FIG. 6 illustrates a block diagram of an example interference mitigation apparatus according to still other aspects.

FIG. 7 illustrates a block diagram of a sample wireless communication environment for interference mitigation in the presence of a dominant interferer.

FIG. 8 depicts a block diagram of a sample base station configured for employing short-term channel measurement for interference mitigation.

FIG. 9 illustrates a block diagram of an example user equipment configured for short-term channel quality reporting according to one or more aspects.

FIG. 10 illustrates a flowchart of a sample methodology for interference mitigation in wireless communication according to aspects of the subject disclosure.

FIG. 11 illustrates a flowchart of an example methodology for employing DM-RSs for short-term channel quality reporting in further aspects.

FIG. 12 depicts a flowchart of a sample methodology for measuring short-term channel quality for mitigating interference according to one or more aspects.

FIG. 13 illustrates a flowchart of an example methodology for employing UE-specific wireless resources for short-term channel measurement.

FIG. 14 depicts a block diagram of an apparatus configured to provide interference mitigation utilizing UE-specific RSs according to one or more aspects.

FIG. 15 illustrates a block diagram of an apparatus for measuring RSs of nearby terminals for short-term channel reporting in wireless interference mitigation.

FIG. 16 illustrates a block diagram of an example wireless communication system for various aspects of the subject disclosure.

FIG. 17 illustrates a block diagram of an example wireless transmit-receive chain facilitating wireless communication according to some disclosed aspects.

FIG. 18 depicts a block diagram of an example communication system to enable deployment of access point base stations within a network environment.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more aspects.

In addition, various aspects of the disclosure are described below. It should be apparent that the teaching herein can be embodied in a wide variety of forms and that any specific structure and/or function disclosed herein is merely representative. Based on the teachings herein one skilled in the art should appreciate that an aspect disclosed herein can be implemented independently of any other aspects and that two or more of these aspects can be combined in various ways. For example, an apparatus can be implemented and/or a method practiced using any number of the aspects set forth herein. In addition, an apparatus can be implemented and/or a method practiced using other structure and/or functionality in addition to or other than one or more of the aspects set forth herein. As an example, many of the methods, devices, systems and apparatuses described herein are described in the context of providing improved network acquisition in the presence of dominant wireless interference, among other things. One skilled in the art should appreciate that similar techniques could apply to other communication environments.

Planned deployments of wireless base stations (BSs) in a wireless access network (AN) typically consider position, spacing and transmission/receive characteristics of transceiver devices. One goal of planned base station deployment is to reduce interference among transmitters. Thus, for instance, one deployment plan might space different base stations apart by a distance approximately equal to their respective maximum transmit ranges. In this type of deployment, signal interference between the base stations is minimized in many circumstances. However, for a mobile terminal near the edge of two adjacent cells, signals of a neighboring cell can be observed with comparable strength as those of a serving cell. In this case, the neighboring cell can cause significant interference to the mobile terminal even in a planned network deployment.

In unplanned or semi-planned BS deployments, wireless transmitters are often not positioned to reduce interference. Instead, it is not unusual with semi or unplanned deployments for two or more transmitting BSs (e.g., that transmit into substantially 360 degrees) to be in close proximity. Furthermore, such deployments often include base stations that transmit at significantly different power, covering a wide range of service areas (e.g., also referred to as a heterogeneous transmit power environment). As an example, a high power BS (e.g., macro cell at 20 watts) may be situated proximate a mid or low power transmitter (e.g., micro cell, pico cell, Femto cell, etc., transmitting at, e.g., 8 watts, 3 watts, 1 watt, and so on). The higher power transmitter can be a significant source of interference for the mid and/or low power transmitters. Furthermore, in some circumstances even lower power transmitters can be a significant source of interference for the high power BS, particularly for terminals very close to such transmitters. Accordingly, signal interference in semi or un-planned environments and/or heterogeneous transmit power environments can often be a significant problem as compared with the conventional planned macro base station AN.

In addition to the foregoing, closed subscriber group (CSG) or restricted access BSs (e.g., an access point BS, HNB, Femto BS, enhanced HNB [HeNB]) can compound problems resulting from semi and un-planned BS deployment. For instance, a CSG BS can selectively provide access to one or more terminal devices, denying network access to other such devices. Accordingly, devices are forced to search for other BSs if denied access, and often observe significant interference from the denying BS. As utilized herein, a CSG BS can also be termed a private BS (e.g., a Femto cell BS or an HNB), or some similar terminology.

Further to the above, un-planned, heterogeneous and CSG deployments can lead to poor geometric conditions for a wireless network. Even without restricted association or closed subscriber groups, a device that observes a very strong signal from a macro BS could be configured to prefer to connect to a Femto BS, because the Femto BS is “closer” to the terminal in terms of path-loss. Thus, the Femto BS is capable of serving the terminal at a comparable data rate while causing less interference to the wireless network. However, if the terminal is not included in a CSG of the Femto BS, the terminal will not be granted access by this preferred BS. Especially when in close proximity to the Femto BS, the terminal can observe significant interference, resulting in a low signal to noise ratio (SNR) at the terminal (e.g., possibly rendering the macro BS undetectable by the terminal). In this scenario, the Femto BS can result in failed network access by the terminal, if pilot signals of the macro BS are not detectable or decodable due to the interference.

Various mechanisms for mitigation or avoiding interference from a strong or a dominant interferer employs channel quality reporting. A user equipment (a UE) will generally measure a wireless channel on which a general base station pilot signal is transmitted, subtract the pilot signal from other signals measured on the wireless channel, and qualify the other signals as noise. This can generally be performed over many signal subframes to derive an average level of interference over those signal subframes. The average level of interference is submitted to a serving base station, which can derive a suitable data rate and transmission power for signals assuming average interference on that wireless channel.

Base station scheduling and resource assignments based on average level of interference data generally achieve good results where most interference observed by the UE comes from multiple non-serving transmitters, and where no single transmitter dominates the average level of interference measured at the UE (also referred to as a dominant interfering transmitter, or just a dominant interferer). Where the dominant interferer does exist, an average level of interference can be insufficient as an accurate prediction of short-term interference on the wireless channel. This is because subframe-by-subframe scheduling decisions of the dominant interferer can significantly affect short-term interference at the UE. In this case, the average level of interference measured over several subframes will not give adequate subframe-by-subframe information to derive accurate data rates, modulation and coding scheme (MCS), resource assignments, or the like, for a given subframe.

In addition to the foregoing, channel quality prediction/reporting based on short-term interference is particularly useful in the presence of strong dominant interferers where a choice of transmission parameters can affect channel quality of an interfered UE. These transmission parameters include power spectral density (PSD), spatial beam, resource assignments, and the like, of an interfering base station. Scenarios with strong dominant interferes can include, for example, in H(e)NB deployments having a CSG. (Note that the term H(e)NB refers to an HNB or alternatively an eHNB, or can refer to both an HNB and an eHNB). As discussed above, a UE communicating with a serving eNB or H(e)NB might come into close proximity with another H(e)NB, thereby experiencing a strong wireless link with that other H(e)NB. However, if the UE cannot obtain service from the other H(e)NB due to CSG access restrictions, the strong wireless link then can become a strong source of interference, dominating the interference observed by the UE.

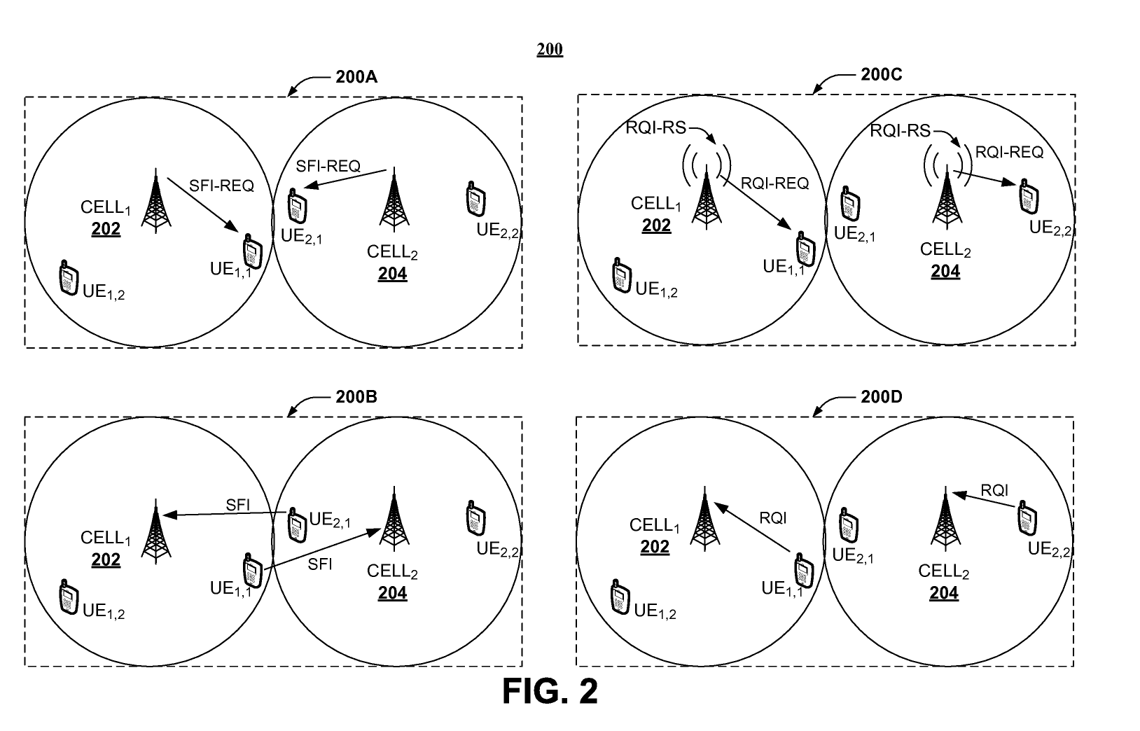

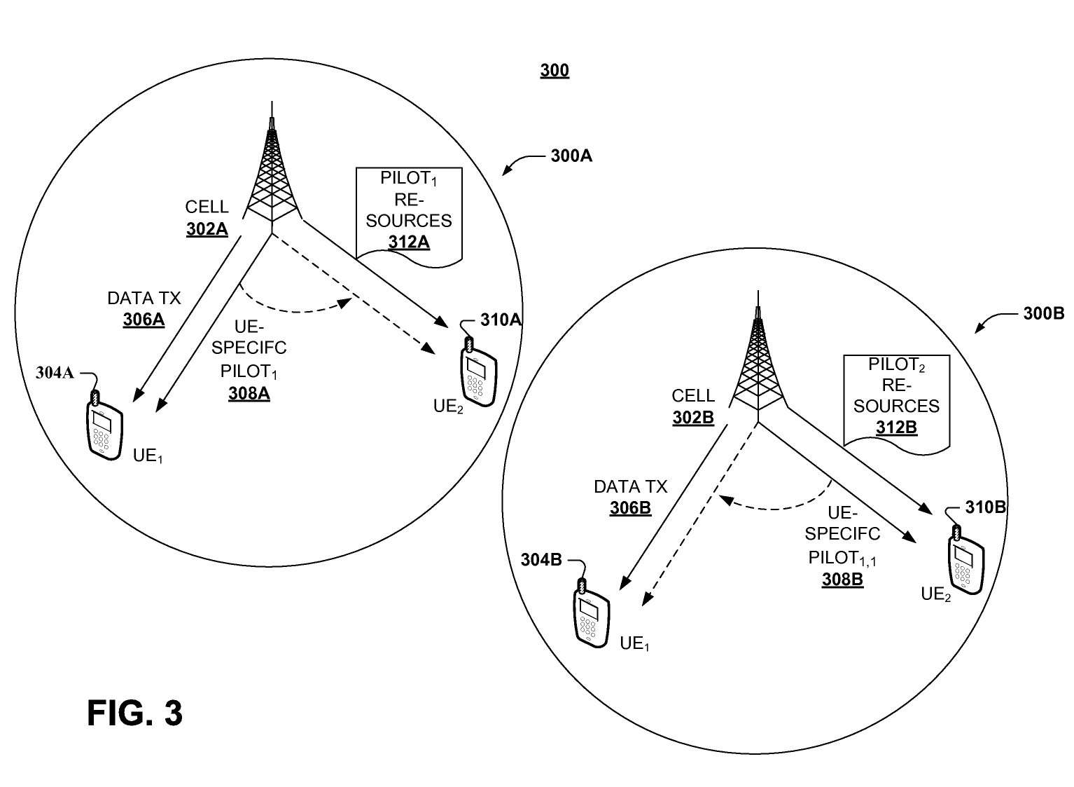

One way to address the problem of dominant interference is to employ dynamic inter-cell interference coordination (ICIC) that provides coordinated resource scheduling among multiple base stations (e.g., see FIGS. 2 and 3, infra). Resource partitioning for long-term ICIC (e.g., where long-term refers to employing a metric of received energy that is aggregated over several signal subframes/subslots and is therefore relatively independent of short-term, subframe-by-subframe scheduling decisions of neighboring cells, enabling less frequent energy measurements and control overhead) typically involves backhaul messaging between wireless network cells for resource partitioning. Further, the ICIC is dynamic in that the resource partitioning can be updated periodically, or updated in response to a change in wireless conditions, to match the resource partitioning to existing wireless conditions.

Another way to address the problem of dominant interference is to obtain and employ short-term interference estimates, on the order of one or two signal subframes, subslots, etc., or less (depending on a nomenclature employed by a particular wireless communication system for scheduling individual transmissions; for instance, third generation partnership project [3GPP] long term evolution [LTE] wireless systems employ a signal subframe as a basic unit of time for scheduling individual transmissions). This latter concept has some additional problems, however, including how to obtain an initial interference estimate when in the presence of a dominant interferer. In other words, a bootstrapping problem exists in generating a suitable reference signal for a UE to measure short-term channel quality, without first having the short-term channel quality information. To address this latter problem, the subject disclosure provides short-term channel quality reporting for a UE, by utilizing reference signals on wireless resources that are not necessarily assigned to that UE. The wireless resources can be assigned to another UE, for instance, or can be unassigned. In addition, the wireless resources can comprise traffic resources, or in some circumstances can comprise control resources, as is described in more detail herein.

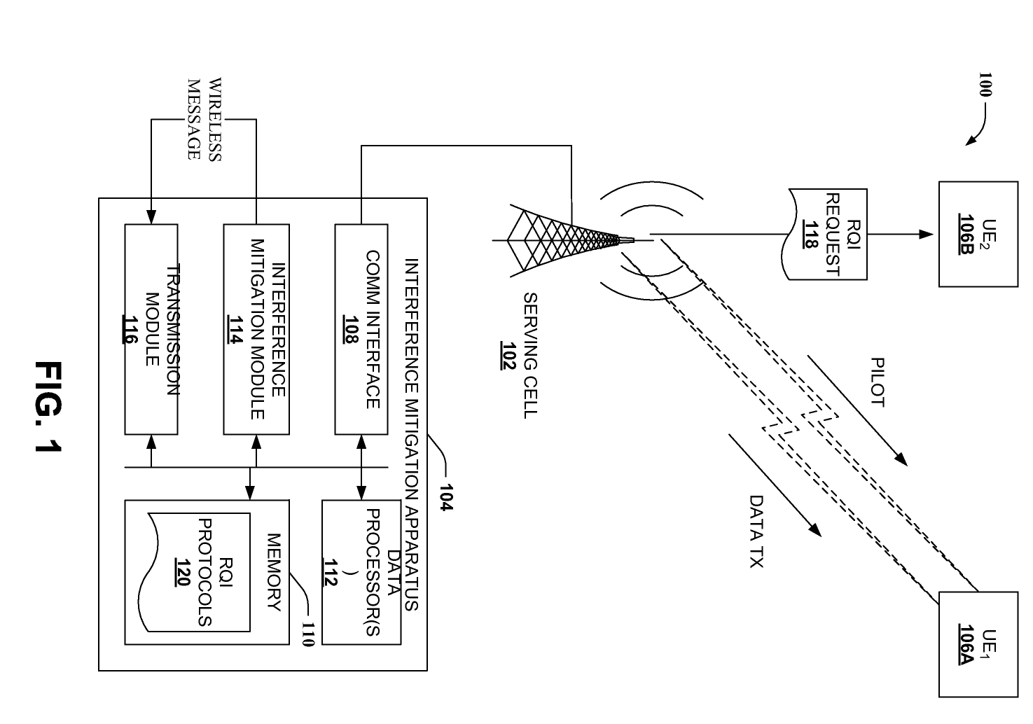

Referring now to the drawings, FIG. 1 depicts a block diagram of an example wireless communication environment 100 according to aspects of the subject disclosure. Wireless communication environment 100 can be employed to implement short-term channel quality reporting (including short-term channel interference measurements, as well as reporting those measurements to a controlling network) in wireless communications. In addition, wireless communication environment 100 can be configured to employ a reference signal (a RS), pilot signal, etc., assigned to a first UE or transmitted on unallocated resources, to obtain short-term channel quality observed by a second UE. Based on this short-term channel quality information, a subsequent UE-specific RS, such as a demodulation RS (a DM-RS), can be assigned to the second UE for further short-term channel quality reporting. In this manner, a serving base station can acquire interference information on an order of one or two subframes or less from the UE, and schedule the UE-specific RS for the second UE utilizing this information.

It should be appreciated that the DM-RS introduced above can be utilized as an actual demodulation reference signal—for demodulating data or control signals—by the first UE. Thus, wireless resources required by the first UE for demodulation, can also be utilized for short-term channel quality reporting by the second UE. Sharing or re-using wireless resources as described above can mitigate or avoid increases in control overhead typical with conventional channel quality reporting mechanisms.

Wireless communication environment 100 includes a serving cell 102 coupled with an interference mitigation apparatus 104. Serving cell 102 is wirelessly coupled with at least two UEs, UE₁ 106A and UE₂ 106B. Serving cell 102 has existing pilot and data transmissions scheduled for UE₁ 106A, as depicted. Further, interference mitigation apparatus 104 is configured to leverage the existing pilot transmission scheduled for UE₁ 106A to assist in interference avoidance for UE₂ 106B.

Interference mitigation apparatus 104 can comprise a communication interface 108 that facilitates communication between interference mitigation apparatus 104 and serving cell 102, or between interference mitigation apparatus 104 and UE₁ 106A and UE₂ 106B, or both. In one aspect, communication interface 108 can comprise a module for electronic communication with serving cell 102 (a communication bus, suitable communication stack; and so on); in another aspect, communication interface 108 can comprise a wireless transmit-receive chain of serving cell 102, or a backhaul interface (not depicted) coupling serving cell 102 with a controlling wireless network (not depicted), or a suitable combination thereof.

In addition to the foregoing, interference mitigation apparatus 104 can comprise a memory 110 for storing instructions configured to provide shared RS allocation for interference mitigation in wireless communication, and a data processor 112 that executes modules for implementing the instructions. Particularly, these modules can comprise a signal allocation module 114 and a transmission module 116. In operation, signal allocation module 114 identifies a data transmission scheduled for a first UE (e.g., UE₁ 106A) served by interference mitigation apparatus 104 and prepares a wireless message that instructs a second UE (e.g., UE₂ 106B) to measure a channel quality metric with respect to a pilot signal associated with the data transmission on a specified set of wireless resources.

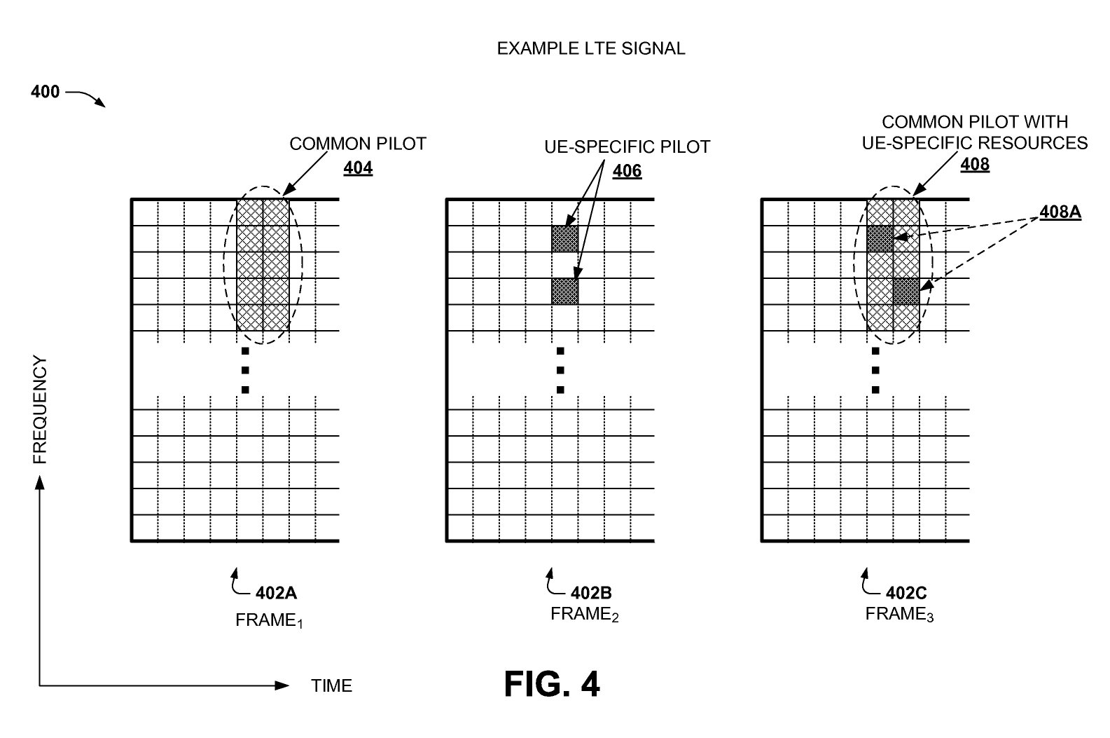

As utilized herein, a measurement pertaining to a specific set of resources, also referred to as a resource-specific measurement, generally involves short-term measurements. In the case of resource-specific channel quality or interference measurements, these short-term measurements are conducted over a time period of one or two signal subframes or less. Further, these short-term measurements can be over a subset of frequency resources (e.g., resource blocks) and a subset of subframes available for assignment to a particular UE. (See FIG. 4, infra, at 402B or 402C, noting that the short-term measurements can be with respect to different time-frequency resource selections at different granularities, e.g., one subframe, a few subframes, one frequency subband, a few subbands, selected in contiguous or non-contiguous frequency or time resource blocks, or a suitable combination thereof, instead of the example wireless resources depicted at 402B or 402C). A resource-specific quality indicator (a RQI) refers to a report of resource-specific channel quality, interference measurements such as signal to interference and noise ratio (SINR), signal to noise ratio (SNR), supported spectral efficiency, or the like, or a suitable combination thereof, and is distinct from a channel quality indicator (CQI). Whereas RQI measurements have a resolution or granularity of one subframe or less, CQI measurements are generally averaged over multiple subframes. Furthermore, as is described herein, a UE can perform RQI measurements on a RS assigned to another UE, or that is unallocated by serving cell 102.

In addition to the foregoing, interference mitigation apparatus 104 comprises transmission module 116. Transmission module sends a wireless message comprising instructions to measure the UE-specific RS assigned to UE₁ 106A to UE₂ 106B for RQI measurements. This wireless message is referred to as an RQI request 118 in wireless communication environment 100. RQI request 118 can also include an instruction to report results of the RQI measurements to serving cell 102, and can optionally specify uplink resources on which to report the results (or the uplink resources can be inferred as part of uplink control plane protocols).

According to one aspect of the subject disclosure, RQI request 118 can be transmitted on downlink control resources. Further, the RQI request 118 can include traffic resources and the associated UE-specific RS with which to measure RQI. In the context of an LTE system, such signaling can be implemented via downlink control information (DCI) format of a physical downlink control channel (a PDCCH), for instance, or resources to be reported can be assigned on a long-term time-scale via an upper layer signaling message (e.g., layer two signaling, layer three signaling, etc.).

Further to the above, transmission module 116 can configure RQI request 118 to assist UE₂ 106B in demodulating the UE-specific RS assigned to UE₁ 106A. In one aspect, transmission module 116 employs cell specific (e.g., physical cell identifier [PCI]-based) scrambling or modulation of the UE-specific RS. This enables UE₁ 106A or UE₂ 106A to descramble or demodulate the UE-specific RS with a PCI code broadcast by serving cell 102, transmitted via non physical layer protocols, or the like. In an alternative aspect, in the event that UE-specific scrambling or modulation is employed for the UE-specific RS, signal allocation module 114 can include applicable UE-specific scrambling or modulation data (e.g., a radio network temporary identifier [RNTI] assigned to UE₁ 106a) with the RQI measurement instruction conveyed by RQI request 118. Upon receiving the UE-specific scrambling or modulation data, UE₂ 106B can then descramble or demodulate the RS on the resources specified for UE₂ 106B, and obtain the resource-specific interference measurements on those specified resources.

By utilizing a RS allocated to UE₁ 106A, serving cell 102 can also provide UE₂ 106B with a RS for RQI reporting, without the benefit of a priori short-term channel quality information from UE₂ 106B. This allows serving cell 102 to schedule subsequent RQI reports for UE₂ 106B with the benefit of a subsequent RS allocated directly to UE₂ 106B. Moreover, this subsequent RS can leverage the RQI reporting previously performed by UE₂ 106B, avoiding inefficiencies of the bootstrap problem described above. This benefit is particularly useful when UE₁ 106A observes moderate to low signal interference.

In at least one alternative embodiment, transmission module 116 configures a pilot signal assigned to UE₁ 106A with a parameter suitable for, or optimized for, demodulation or reception at UE₂ 106B. This parameter can comprise a beamforming parameter (e.g., that directs the pilot signal spatially toward UE₁ 106B), a precoding parameter, or the like, configured to improve signal reception at UE₂ 106B, optionally at the expense of signal reception at UE₁ 106A. This alternative embodiment can be employed, for instance, where UE₁ 106A observes relatively low signal interference, and will not suffer significant reception problems as a result of configuring the parameter for demodulation or reception at UE₂ 106B.

Various implementation alternatives can be selected based on conditions specified in a set of RQI protocols 120 stored in memory 110. For instance, these RQI protocols 120 can specify cell-specific RQI reporting for a wireless system that employs cell-specific RSs. Alternatively, RQI protocols 120 can specify whether to include UE-specific scrambling or modulation information for wireless systems that employ UE-specific scrambling or modulation, for instance. As yet another alternative, RQI protocols 120 can specify whether to optimize a transmission parameter(s) of a pilot signal associated with UE₁ 106A for improved reception at UE₂ 106B, or can specify a degree of optimization (e.g., on a sliding scale that decreases or increases pilot signal optimization) for reception by UE₂ 106B based on a level of interference observed by UE₁ 106A, a level of interference observed by UE₂ 106B, or a suitable ratio of interference observed by UE₁ 106A versus UE₂ 106B, or the like.

FIG. 2 illustrates a diagram of an example of inter-cell interference coordination 200 for a wireless communication environment. Particularly, inter-cell interference coordination 200 comprises a first stage 200A, a second stage 200B, a third stage 200C and a fourth stage 200D. Further, inter-cell interference coordination 200 involves a cell 202 that is a serving cell for two UEs, UE_{1,1} and UE_{1,2}, and a cell₂ 204 that is a serving cell for two additional UEs, UE_{2,1} and UE_{2,2}. Further, because UE_{1,1} and UE_{2,1} are located near a cell boundary of cell₁ 202 and cell₂ 204 (depicted by the circles that encompass the respective cells), these UEs can observe significant interference from a dominant interferer (e.g., cell₂ 204 can be a dominant interferer for UE_{1,1} or cell₁ 202 can be a dominant interferer for UE_{2,1}). During first stage 200A, cell₁ 202 and cell₂ 204 transmit respective spatial feedback information requests (SFI-REQS) to their respective UEs that are observing significant interference. These SFI-REQs can be unicast to the respective UEs, as depicted, or can be broadcast or multicast in alternative aspects. An SFI-REQ message instructs a UE (UE_{1,1} and UE_{2,1}) to initiate inter-cell interference coordination with its dominant interfering cell.

At second stage 200B, UE_{1,1} performs a quality or interference measurement of a wireless channel between UE_{1,1} and cell₂ 204, and transmits an SFI report comprising a result of the measurement to cell₂ 204. Likewise, UE_{2,1} performs a quality or interference measurement of a wireless channel between UE_{2,1} and cell₁ 202, and transmits a corresponding SFI report comprising a result of this latter measurement to cell₁ 202. The respective SFI reports are transmitted as uplink control messages sent to respective dominant interferers, which convey an explicit or an implicit request for ICIC by the recipient dominant interferer. Furthermore, the SFI reports can be sent as broadcast messages, unicast messages, multicast messages, or the like.

At third stage 200C, cell₁ 202 and cell₂ 204 respond to the respective RQI-REQ messages (and the ICIC request) received from UE_{2,1} and UE_{1,1}, respectively, by making a pre-scheduling decision that takes into account details of the ICIC request. These details can include a priority (e.g., quality of service [QoS]) of traffic of the requesting UE (optionally relative a priority of traffic of a UE that might be affected by the ICIC request), a buffer level of the requesting UE, channel measurement data of the requesting UE, or the like, or a suitable combination thereof. The pre-scheduling decision can also account for similar details (e.g., priority, buffer level, channel measurement data, etc.) of UEs served by a cell that might be affected by any given pre-scheduling decision. A result of the pre-scheduling decision typically involves transit parameter selection for UEs served by respective cells. These transmit parameters can include transmit power (e.g., PSD), spatial beam orientation, or the like. In at least one aspect, the transmit parameters can include selecting orthogonal resources that cause less interference to the requesting UE, or blanking the wireless channel between a cell and the requesting UE for a subframe or fraction thereof.

Once the pre-scheduling decision is determined, cell₁ 202 and cell₂ 204 transmit a resource-specific quality indicator reference signal (a RQI-RS) that is consistent with the decided transmission parameters. In addition, cell₁ 202 and cell₂ 204 commit to maintaining these transmission parameters on one or more subsequent traffic transmissions, for example, on traffic time-frequency resources associated with the respective RQI-RSs received by the respective cells. In addition, cell₁ 202 and cell₂ 204 also transmit a RQI-REQ to UE_{1,1} and UE_{2,1}, respectively, instructing those UEs to report short-term resource specific channel quality measured on RQI-RSs transmitted by various surrounding base stations (e.g., including their respective dominant interferers, cell₂, 204 and cell₁ 202, respectively). The RQI-RSs can be transmitted on downlink control resources, and will generally be unicast, but can be broadcast or multicast instead. In at least one aspect (although not depicted by inter-cell interference coordination 200), the RQI-RSs can be transmitted in conjunction with the SFI-REQ messages at first stage 200A.

At fourth stage 200D, UE_{1,1} and UE_{2,1} transmit RQI reports based at least on the RQI-RSs transmitted by cell₂ 204 and cell₁ 202, respectively. These RQI reports are in response to the RQI-REQ messages transmitted at third stage 200C (or at first stage 200A), and are received by the respective serving cell, cell₁ 202 and cell₂ 204. Additionally, because the RQI-RSs transmitted by the respective cells are consistent with the pre-scheduling transmission parameters, the RQI reports will reflect the pre-scheduling transmission parameters of at least the dominant interfering cells. Upon receiving the RQI reports, the serving cells can make final scheduling decisions, and perform rate prediction, MCS assignment, and the like, for subsequent downlink transmissions. It is to be appreciated, that inter-cell interference coordination 200 is depicted for downlink interference measurements, it can be conducted instead for uplink interference measurements, appropriately modified for the case where the UEs are transmitting and the cells are receiving.

FIG. 3 illustrates a diagram 300 of shared pilot signaling employed for initial short-term channel quality measurements according to particular aspects of the subject disclosure. A first example of the shared pilot signaling is depicted at diagram 300A. Diagram 300A comprises a wireless cell 302A serving multiple UEs, including UE₁ 304A and UE₂ 310A. After receiving initial channel quality reporting (e.g., CQI reports), cell 302A determines that UE₁ 304A is observing moderate to little signal interference, whereas UE₂ 310A is observing high signal interference. Accordingly, cell 302A schedules a data transmission 306A for UE 304A along with a pilot signal for demodulation of data transmission 306A. In the case depicted for diagram 300A, the pilot signal is transmitted with parameters optimized for reception by UE₁ 304A, and is denoted UE-specific pilot₁ 308A. The parameters can include beamforming, transmit power (e.g., PSD), time-frequency resource selection (e.g., selected based on earlier CQI reports, or an earlier RQI report as described herein), or the like, or a suitable combination thereof.

In conjunction with scheduling data transmission 306A and UE-specific pilot₁ 308A, cell 302A transmits pilot₁ resource message 312A to UE₂ 310A. Pilot₁ resource message 312A includes information to assist UE₂ 310A in receiving, demodulating or decoding/descrambling UE-specific pilot₁ 308A. In general, this information can comprise time-frequency resources on which UE-specific pilot₁ 308A is scheduled for transmission, the transmission parameters optimized for reception by UE₁ 304A, such as the beamforming or transmit power resources, and so on. In one aspect of the subject disclosure, the time-frequency resources on which UE-specific pilot₁ 308A is scheduled for transmission can be reserved for a subsequent data transmission/pilot transmission to UE₂ 310A. This way RQI measurements performed on these time-frequency resources can be applied to the subsequent data/pilot transmission. In another aspect, a subset of time-frequency resources on which UE-specific pilot₁ 308A is transmitted are specified in pilot₁ resource message 312A. In this case, the subset of time-frequency resources can be reserved for the subsequent transmission to UE₂ 310A, and another subset of the time-frequency resources can be reserved for a subsequent transmission to UE₁ 304A.

Further, if UE-specific pilot₁ 308A is modulated or scrambled with a cell-specific identifier (e.g., PCI) known to UE₂ 310A, pilot₁ resource message 312A can, but need not, specify the cell-specific identifier. On the other hand, if UE-specific pilot₁ 308A is modulated or scrambled with a UE-specific identifier (e.g., RNTI), then pilot₁ resource message 312A will include this UE-specific identifier. Once UE-specific pilot₁ 308A is transmitted by cell 302A, UE₂ 310A will attempt to receive and demodulate signal energy from this transmission. This signal energy is depicted in diagram 300A as a dotted line that reaches UE₂ 310A as a result of the transmission of UE-specific pilot₁ 308A to UE₁ 304A.

Diagram 300B depicts an alternate aspect of the subject disclosure. In diagram 300B, a serving cell 302B instructs UE₁ 304B and UE₂ 310B to submit respective carrier to interference (CIR) level reports. Cell 302B then schedules a data transmission 306B and associated pilot signal (e.g., a DM-RS) for the data transmission. Based on a CIR level of UE₁ 304B, a CIR level of UE₂ 310B or both, cell 302B will at least in part optimize transmission parameters of the associated pilot signal in favor of UE₂ 310B, to obtain a UE-specific pilot₂ 312B (where pilot₂ indicates transmission parameters at least partially optimized for UE₂ 310B). This can help to improve reception of UE-specific pilot₂ 308B at UE₂ 310B, particularly where UE₂ 310B observes strong interference.

In cases where UE₁ 304B observes low interference, optimizing UE-specific pilot₂ 308B partially or wholly for UE₂ 310B may not significantly hinder reception of signal energy (depicted by the dotted line) from UE-specific pilot₂ 308B transmitted to UE₂ 310B. In at least one particular aspect, cell 302B can select UE₁ 304B from a group of UEs (not depicted) served by cell 302B based on low observed CIR level. This selection can lessen an impact of configuring UE-specific pilot₂ 308B for UE₂ 310B on reception by UE₁ 304B.

Similar to diagram 300A, above, cell 302B transmits a pilot₂ resource message 312B to UE₂ 310B specifying transmission parameters of UE-specific pilot₂ 308B, including transit power, beamforming parameters, etc. In addition, pilot₂ resource message 312B will specify time-frequency resources on which UE-specific pilot₂ 308B is transmitted, or at least a subset of these time-frequency resources, for RQI measurements by UE₂ 310B. In one aspect, pilot₂ resource message 312B will further include a UE-specific identifier of UE₁ 304B, to facilitate decoding of UE-specific pilot₂ 308B at UE₂ 310B. In another aspect, however, cell 302B can instead modulate or scramble UE-specific pilot₂ 308B with a UE-specific identifier of UE₂ 310B, and transmit this latter UE-specific identifier to UE₁ 304B.

Although not depicted, cell 302A or cell 302B could use a broadcast pilot instead of UE-specific pilot₁ 308A or UE-specific pilot₂ 308B. In this case, a select set of resources can be employed for a pilot signal associated with data transmission 306A or data transmission 306B. Further, the same set of resources can be specified for RQI measurements by UE₂ 310A or UE₂ 310B, or a different set of resources can be specified for the RQI measurements (see FIG. 4, infra, for examples of resource allocation for RQI measurements). In either case, the set of resources on which UE₂ 310A or UE₂ 310B perform RQI measurements are later reserved for at least one subframe for downlink transmissions to UE₂ 310A or UE₂ 310B.

FIG. 4 illustrates a block diagram 400 of example wireless resources for shared pilot transmissions in the context of short-term interference reporting, according to additional aspects of the subject disclosure. Block diagram 400 includes time-frequency graphs of three different example wireless time frames. Specifically, Frame₁ 402A, Frame₂ 402B and Frame₃ 402C depict example time-frequency resources for respective time frames of an LTE wireless system.

Frame₁ 402A depicts a set of time-frequency resources (cross-hatch boxes) allocated to a common pilot 404. Common pilot 404 can be a cell-specific pilot, a broadcast pilot, multicast pilot, or the like. As depicted, common pilot 404 is allocated to five contiguous frequency subbands, in two consecutive OFDM symbols (orthogonal frequency division multiplex symbols). Common pilot 404 could be one suitable example of an RQI-RS transmitted by a base station for downlink RQI measurements by one or more UEs (e.g., in an ICIC arrangement such as depicted at FIG. 2, supra), although RQI-RS is not limited by this example.

Frame₂ 402B illustrates a set of time-frequency resources (shaded boxes) allocated to a UE-specific pilot 406. This set of time-frequency resources comprises two non-contiguous frequency subbands on a single OFDM symbol (although many other examples of UE-specific pilot resources can be employed, with more or fewer resources on various subbands or OFDM symbols). In one instance, UE-specific pilot 406 can be a DM-RS sent in conjunction with a data transmission, for descrambling or demodulating the data transmission (e.g., see FIG. 3, supra). Further, the selected time-frequency resources of UE-specific pilot 406 can be optimized for a UE receiving the data transmission in one aspect disclosed herein. In an alternative aspect, the selected time-frequency resources can be optimized for short-term interference measurements of a second UE instead, as described herein. In either case, the shaded boxes allocated to UE-specific pilot 406 are assigned to the second UE in a later time frame (not depicted), if that second UE utilizes UE-specific pilot 406 for RQI measurements in Frame₂ 402B.

Frame₃ 402C illustrates a block diagram of a set of time-frequency resources (cross-hatched boxes) allocated to a common pilot 408, with a subset of these time-frequency resources (shaded boxes) allocated to a specific UE. The UE-specific resources 408B can be provided as a DM-RS or other UE-specific pilot, or for a resource-specific RQI measurement utilizing the common pilot. In this context, common pilot 408 can be employed for multiple UE-specific purposes, by allocating different subsets of resources to various UE-specific purposes.

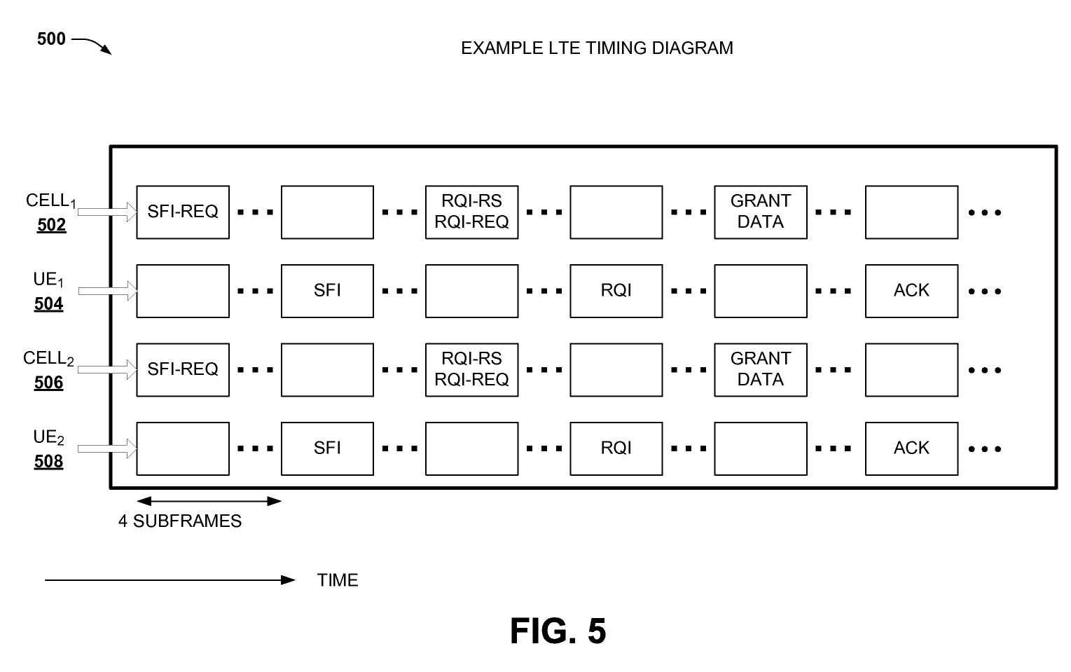

FIG. 5 illustrates a block diagram of an example timing diagram 500 for an example ICIC based on an LTE wireless communication system. It should be appreciated that timing diagram 500 can be applied to other wireless communication systems, having signal time-divisions other than the LTE subframe, for instance. The example ICIC of timing diagram 500 includes communication between a first cell (cell₁ 502) serving a first UE (UE₁ 504), and a second cell (cell₂ 506) within wireless range of the first UE, that in turn serves a second UE (UE₂ 508). In at least one aspect of the subject disclosure, timing diagram 500 can correspond with the ICIC diagrams of FIG. 2, supra.

Starting from the left at a (relative) time block=0, cell₁ 502 and cell₂ 506 transmit SFI-REQ messages to their respective UEs. After receiving the respective SFI-REQs, UE₁ 504 and UE₂ 508 begin transmitting SFI data (e.g., four subframes later in timing diagram 500) to their respective dominant interfering cells (e.g., cell₂ 506 and cell₁ 502, respectively). Upon receiving SFI reports, cell₁ 502 and cell₂ 506 transmit respective RQI-REQs and RQI-RSs. The RQI-REQ instructs a serving UE to perform RQI measurements on a RQI-RS(s) transmitted by a neighboring base station(s), optionally with respect to a specified set of time-frequency resources. In response, UE₁ 504 and UE₂ 508 transmit respective RQI reports to their respective serving cells, cell₁ 502 and cell₂ 506, which respond in the next time block with grant data for downlink (or uplink, for uplink interference mitigation) data transmissions. The UEs can then acknowledge the grant data in the final time blocks.

Timing diagram 500 illustrates the delay in between cell and UE transmissions. In this example, a four-subframe delay exists between the start of subsequent blocks. This delay leads to additional inefficiencies. For instance, a serving cell must collect RQI from a UE exposed to strong interference, but this UE can be scheduled. For timing diagram 500, a minimum delay of eight subframes exists between a pre-scheduling decision taken in conjunction with RQI-RS and RQI-REQ transmission (third block from the left), and transmission of downlink grant/traffic data. This minimum delay assumes no SFI-REQ and SFI report steps are included; otherwise, the delay jumps to sixteen subframes. Further, if each cell transmits separate RQI-RSs to respective UEs served by those cells, control overhead becomes significant. Accordingly, utilizing an RS that is not specifically allocated to a UE for RQI reporting by that UE (a shared RS) can both reduce the minimum delay, by performing RQI reporting with a previous DM-RS, as well as reduce control overhead (e.g., by employing a single DM-RS both for demodulating a traffic transmission of a first UE, and for RQI reporting of a second UE).

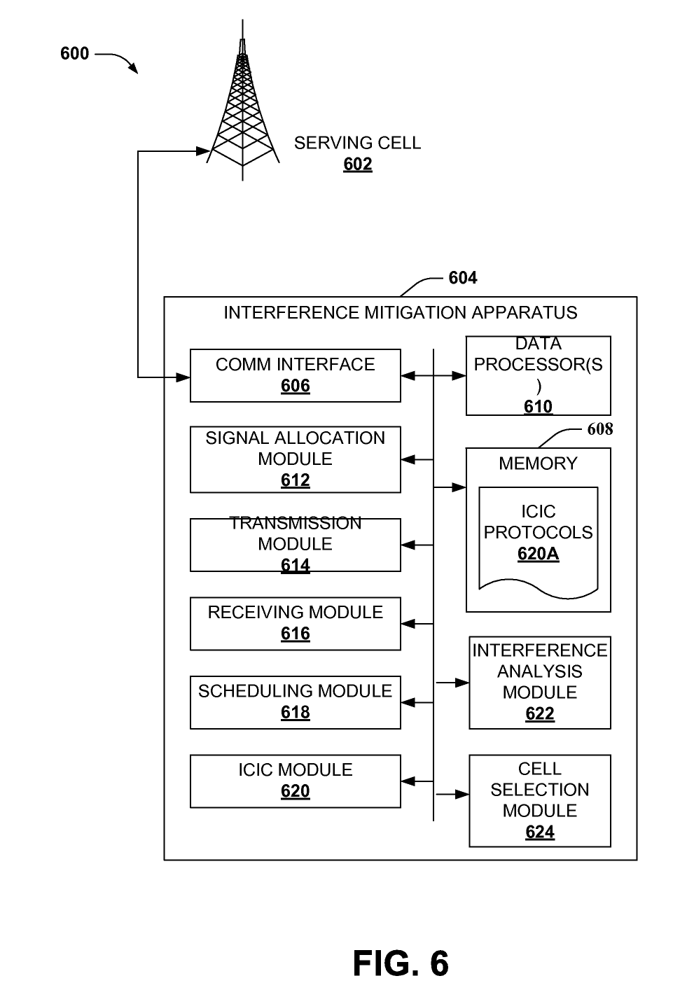

FIG. 6 illustrates a block diagram of an example wireless system 600 for interference mitigation, according to one or more particular aspects of the subject disclosure. Wireless system comprises a serving cell 602 coupled with an interference mitigation apparatus 604. Serving cell 602 can include an eNB base station, or a HeNB base station, or other suitable base station (e.g., base transceiver subsystem [BTS]), depending on a type of wireless system employed for wireless system 600 (e.g., LTE, wireless interoperability for microwave access [WiMAX], global system for mobile communication [GSM], ultra mobile broadband [UMB], and so on). Additionally, interference mitigation apparatus 604 can be physically co-located with serving cell 602, or can be remotely located (e.g., at a base station controller [BSC]), communicating with serving cell 602 via a backhaul link, or other suitable wired or wireless link.

Interference mitigation apparatus can comprise a communication interface 606 for communicating with serving cell 602, or for communicating via serving cell 602 with one or more UEs wirelessly coupled thereto. Additionally, interference mitigation apparatus 604 can comprise memory 608 for storing instructions pertaining to interference mitigation in wireless communications, and a data processor 610 for executing one or more modules to implement the instructions.

Particularly, the modules can include a signal allocation module 612 that identifies a data transmission scheduled for a first UE served by serving cell 602, and that generates an instruction for a second UE to measure interference to a pilot signal associated with the data transmission on a specified set of wireless resources. A transmission module 614 is then executed that sends a wireless message comprising the instruction to the second UE. In some aspects, the measured interference is for a short duration, such as one or two subframes, averaged over a single subframe or less. This enables the measured interference to potentially reflect interference resulting from subframe-by-subframe scheduling decisions of a dominant interferer, for instance.

In at least one aspect of the subject disclosure, the pilot signal associated with the data transmission is configured with a similar beamforming parameter, precoding parameter or power control parameter as the data transmission. Further, the pilot signal comprises signal at least on a set of wireless resources specified in the instruction. In an alternative or additional aspect, the pilot signal is a UE-specific demodulation signal transmitted in conjunction with the data transmission and configured at least in part to assist the first UE in demodulating the data transmission. In yet another alternative aspect, the pilot signal is a common pilot employed by a wireless cell that comprises signal energy on a superset of wireless resources of which the set of wireless resources is a subset. In this latter case, the second UE measures interference on the set of wireless resources, and ignores other time-frequency resources on which the common pilot is transmitted on.

In addition to the foregoing, if the pilot signal is scrambled, the instruction could contain information with which the second UE can descramble the pilot signal. For instance, if the pilot signal is a UE-specific demodulation signal scrambled with an identifier of the wireless cell that is known to the second UE, the instruction need not contain this information. On the other hand, if the pilot signal is a UE-specific demodulation signal scrambled with an identifier of the first UE, the wireless message specifies the identifier of the first UE, to enable the second UE to descramble the pilot signal.

According to still other aspects of the subject disclosure, interference mitigation apparatus 604 can comprise a receiving module 616 that obtains a resource-specific channel quality report from the second UE (e.g., an RQI report). This resource-specific interference report will generally be a control message sent on an uplink control channel in response to the wireless message and instruction to measure interference. Further, a scheduling module 618 can be employed that provides an uplink transmission grant or downlink transmission grant to the second UE at least in part based on the resource-specific channel quality report.

According to an additional aspect, interference mitigation apparatus 604 can comprise an ICIC module 620 that forwards a SFI report to an interfering cell as part of interference mitigation. This SFI report can be configured to be a report that includes a measurement of interference caused by the interfering cell to one or more UEs served by the apparatus. Further, the SFI report can be transmitted by ICIC module 620 to the interfering cell over a backhaul network, or can be transmitted directly to the interfering cell by the second UE in an uplink wireless message. According to a particular aspect, the SFI report can be transmitted by ICIC module 620 prior to transmission of the wireless message to the second UE, to cause the interfering cell to make and commit to a pre-scheduling decision with regard to the set of wireless resources. Accordingly, interference to the pilot signal measured by the second UE on the set of wireless resources then includes a transmission parameter(s) selected by the interfering cell on the set of wireless resources. In at least one aspect, the transmission parameter(s) includes beamforming or power reduction configured by the interfering cell to reduce interference to the second UE on the set of wireless resources.

In one or more other aspects, ICIC module 620 can be triggered by one or more wireless conditions established in a set of ICIC protocols 620A stored in memory 608. These protocols can specify a threshold CIR level (see below) observed by the second UE, for instance, that triggers the SFI report. As another example, scheduling delay resulting from implementation of the SFI report can also be factored into this triggering, to minimize scheduling delay. As another aspect, ICIC protocols 620A can comprise code specifying a trade-off in scheduling delay versus CIR level for as a condition for triggering the SFI report.

In still other aspects, interference mitigation apparatus 604 comprises an interference analysis module 622 that request the first UE and the second UE to measure respective CIR levels observed by the first UE and the second UE, and to transmit respective CIR reports to serving cell 602. In this case, a cell selection module 624 can be employed that schedules the data transmission for the first UE on the set of wireless resources at least in part because a first CIR level measured by the first UE is above a target CIR level, or because a second CIR level measured by the second UE is below the target CIR level, or a suitable combination thereof. As one optional implementation, cell selection module 624 schedules the data transmission for the first UE on the set of wireless resources based additionally on a fairness constraint or on a long-term projected scheduling utility for the first UE or the second UE. As another optional implementation, transmission module 614 configures the pilot signal with a beamforming parameter or a precoding parameter optimized for reception of the pilot signal by the second UE, based on the first CIR level, the second CIR level, or a suitable ratio of the first CIR level and the second CIR level.

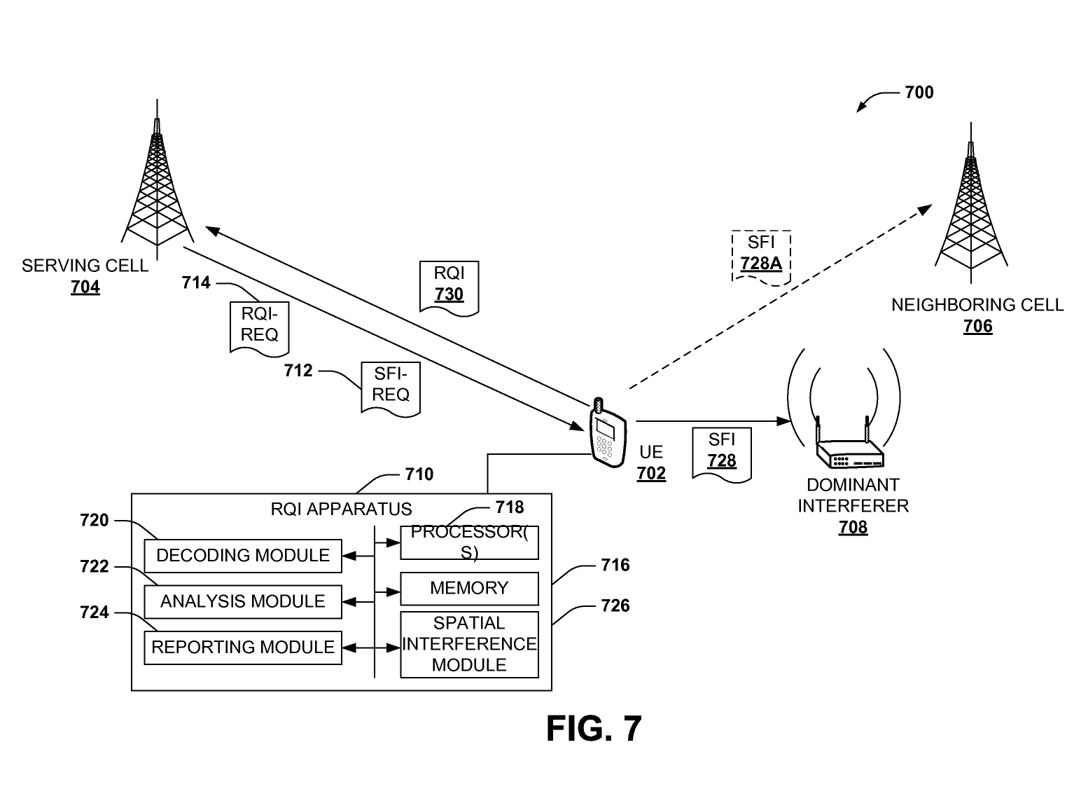

FIG. 7 depicts a block diagram of an example wireless system 700 for ICIC for a terminal in the presence of a dominant interferer. Wireless system 700 comprises a UE 702 wirelessly coupled with a serving cell 704. In addition, UE 702 is within signal range of a neighboring cell 706 and a dominant interferer 708 that each contribute to interference observed at UE 702. However, dominant interferer 708 forms a majority of this interference. Further, dominant interferer 708 is a CSG base station such as a H(e)NB that is configured to refuse wireless service to UE 702; accordingly, UE 702 cannot conduct a handover to dominant interferer 708 to avoid this source of interference.

To mitigate interference, UE 702 employs an RQI apparatus 710. RQI apparatus 710 can comprise a memory 716 for storing instructions configured to provide short-term resource-specific interference reporting for wireless communications, and a data processor 718 for executing modules to implement the instructions. Particularly, RQI apparatus 710 can comprise a decoding module 720 that identifies a wireless message 714 (e.g., a RQI-REQ) within a downlink transmission instructing UE 702 to measure resource-specific interference to a pilot signal transmitted by serving cell 704. In an LTE system, for instance, wireless message 714 can be in a downlink control information (DCI) format where the downlink transmission is conveyed on a physical downlink control channel (PDCCH).

As utilized herein, resource-specific interference refers to a level of interference observed on a particular set of time-frequency resources (or other wireless resources) on which the pilot signal is transmitted (although the pilot signal can also be transmitted on other wireless resources as well). In one aspect of the subject disclosure, wireless message 714 explicitly or implicitly identifies a set of time-frequency resources for the measurement of resource-specific interference to the pilot signal.

In addition to the foregoing, RQI apparatus 710 can comprise an analysis module 722 that acquires information for identifying and decoding the pilot signal from wireless message 714, and that measures the resource-specific interference to the pilot signal. In at least one aspect, the measurements can be performed with a time-based precision of substantially one subframe. Further to the above, RQI apparatus 710 can comprise a reporting module 724 that forwards a measurement result 630 (e.g., an RQI report) of the resource-specific interference to serving cell 704. In at least one aspect, measurement result 630 can be a channel quality parameter derived from the resource-specific interference (e.g., based on estimated channel gain and the resource-specific interference), which reporting module 724 forwards to serving cell 704. The measurement result is utilized by serving cell 704 to improve a CIR observed by UE 702 on the set of time-frequency resources associated with the resource-specific interference.

In at least one aspect of the subject disclosure, analysis module 722 can be configured to trigger resource-specific interference measurements based on a non-resource specific measure of interference. For instance, analysis module 722 can be configured to identify a high level of interference in a channel quality measurement, and transmit a result of this non-resource specific measure of interference in a CQI report. If the interference is high, serving cell 704 can send wireless message 714 to UE 702, which triggers resource-specific interference protocols at UE 702, as described herein, to mitigate the high level of interference.

The pilot signal employed for interference measurements can comprise one of various types of signals. In one aspect, the pilot signal is a common pilot employed by the serving cell. In this case, analysis module 722 employs a cell-wide identifier (e.g., a PCI) to decode and receive the pilot signal. In another aspect, the pilot signal is a UE-specific pilot signal (a UE pilot) configured at least in part for a second UE (not depicted) associated with serving cell 704. For instance, the UE pilot can be a UE DM-RS associated with a data transmission that targets the second UE. In this case, wireless message 714 specifies a transmission, scrambling, or modulation parameter (e.g., a precoding parameter, a beamforming parameter or a scrambling code) required to decode the UE DM-RS. In yet another aspect, the pilot signal is a UE pilot that comprises a beamforming parameter or a precoding parameter favorable to UE 702 (e.g., that is at least in part optimized for reception by UE 702).

According to an additional aspect, RQI apparatus 710 can comprise a spatial interference module 726. Spatial interference module 726 can be employed to incorporate ICIC between serving cell 704 and one or more of neighboring cell 706 or dominant interferer 708. To facilitate the ICIC, spatial interference module 726 employs decoding module 720 to receive an instruction 712 (e.g., a SFI-REQ) to provide a SFI report to one or more interfering cells. In one aspect, the instruction can specify to send the SFI report only to dominant interferer 708, whereas in other aspects, the instruction can specify to send the SFI report to multiple interfering cells, having interference above a minimum threshold, for instance. In either case, spatial interference module 726 can employ analysis module 722 to measure quality of a first wireless channel between dominant interferer 708 and UE 702 (and optionally a second wireless channel between neighboring cell 706 and UE 702). Spatial interference module 726 can then employ reporting module 724 to forward a channel quality indicator of the first wireless channel either over-the-air directly to dominant interferer 708 in an SFI message 728 (and optionally forward a similar SFI message 728A comprising a channel quality indicator of the second wireless channel to neighboring cell 706), or indirectly via serving cell 704. In this manner, pre-scheduling decisions can be implemented by dominant interferer 708 or neighboring cell 706 and reflected in respective pilot signals transmitted by dominant interferer 708 or neighboring cell 706, on the same time-frequency resources for which the pilot signal measured by UE 702 is transmitted. Accordingly, the resource-specific interference measurements performed by analysis module 722 can reflect these pre-scheduling decisions of dominant interferer 708 or neighboring cell 706.

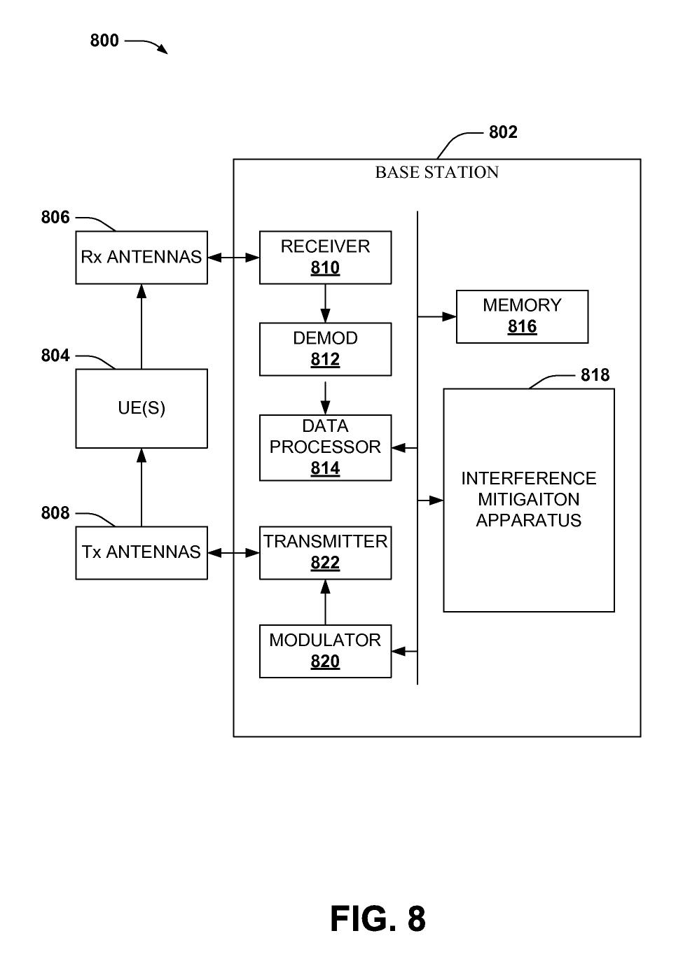

FIG. 8 illustrates a block diagram of an example system 800 comprising a base station 802 configured for aspects of the subject disclosure. For instance, base station 802 can be configured to implement shared pilot signal utilization for resource-specific interference measurements for one or more UEs 804. In at least one example, base station 802 is configured to identify a first UE observing high interference, and a second UE observing mid to low interference. Additionally, base station 802 can be configured to schedule a data transmission and UE-specific pilot for the second UE, and instruct the first UE to measure the UE-specific pilot for interference on a set of time-frequency resources. According to one aspect, base station 802 can also be configured to update the first UE with information required to identify, descramble or decode the UE-specific pilot, such as an RNTI of the second UE. Further, base station 802 can be configured to allocate the set of time-frequency resources to the first UE for a subsequent transmission, and configure the subsequent transmission at least in part based on the interference measured by the first UE on the set of time-frequency resources.

Base station 802 (e.g., access point, . . . ) can comprise a receiver 810 that obtains wireless signals from one or more of UEs 804 through one or more receive antennas 806, and a transmitter 830 that sends coded/modulated wireless signals provided by modulator 828 to the AT(s) 804 through a transmit antenna(s) 808. Receiver 810 can obtain information from receive antennas 806 and can further comprise a signal recipient (not shown) that receives uplink data transmitted by AT(s) 804. Additionally, receiver 810 is operatively associated with a demodulator 812 that demodulates received information. Demodulated symbols are analyzed by a data processor 814. Data processor 814 is coupled to a memory 816 that stores information related to functions provided or implemented by base station 802. In one instance, stored information can comprise ICIC protocols for initiating and implementing ICIC between base station 802 and one or more other base stations causing interference to UE(s) 804, as described herein. Further, data processor 814 can execute an interference mitigation apparatus 818 to implement functions related to resource-specific interference mitigation, as described herein (e.g., see FIGS. 1 and 6, supra).

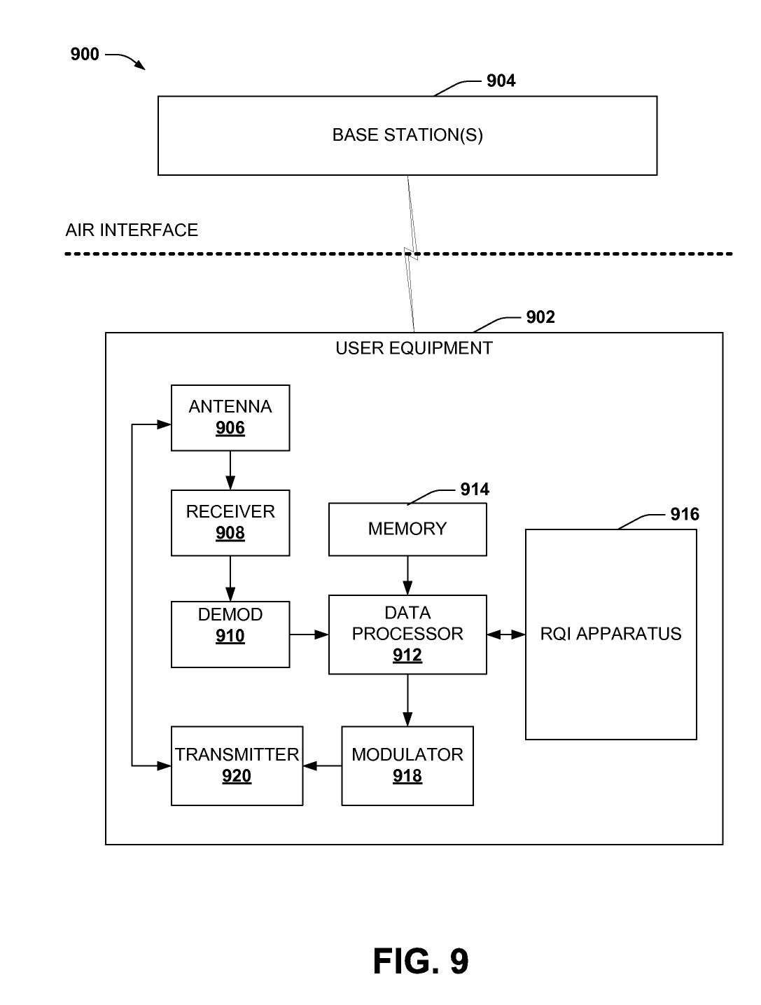

FIG. 9 illustrates a block diagram of an example wireless communication system 900 comprising a UE 902 according to one or more additional aspects of the subject disclosure. UE 902 can be configured to wirelessly communicate with one or more base stations 904 (e.g., access point(s)) of a wireless network. Based on such configuration, UE 902 can receive wireless signals from base station(s) 904 on one or more forward link channels and respond with wireless signals on one or more reverse link channels. In addition, UE 902 can comprise instructions stored in memory 914 for performing resource-specific interference measurements on a UE-specific pilot signal associated with another UE (not depicted), and a data processor 912 to execute an RQI apparatus 916 that implements these instructions, as described herein (e.g., see FIG. 7, supra). Particularly, the resource-specific interference measurements can be implemented if UE 902 receives an instruction from base station 904 to implement these instructions, or if UE 902 observes high interference from a dominant interferer, and receives a set of time-frequency resources for an impending traffic transmission. UE 902 includes at least one antenna 906 (e.g., comprising one or more input/output interfaces) that receives a signal and receiver(s) 908, which perform typical actions (e.g., filters, amplifies, down-converts, etc.) on the received signal. In general, antenna 906 and a transmitter 922 (collectively referred to as a transceiver) can be configured to facilitate wireless data exchange with base station(s) 904.

Antenna 906 and receiver(s) 908 can also be coupled with a demodulator 910 that can demodulate received symbols and provide demodulated symbols to a data processor(s) 912 for evaluation. It should be appreciated that data processor(s) 912 can control and/or reference one or more components (antenna 906, receiver 908, demodulator 910, memory 914, RQI apparatus 916, modulator 928, transmitter 930) of UE 902. Further, data processor(s) 912 can execute one or more modules, applications, engines, or the like that comprise information or controls pertinent to executing functions of UE 902.

Additionally, memory 914 of UE 902 is operatively coupled to data processor(s) 912. Memory 914 can store data to be transmitted, received, and the like, and instructions suitable to conduct wireless communication with a remote device (e.g., base station 904). In addition, memory 914 can comprise an access protocol 914A employed to perform conventional network access requests to BS(s) 904. Additionally, memory 914 can comprise modified access protocol 914B to obtain limited access for network acquisition, if the convention network access request is rejected by BS(s) 904.

The aforementioned systems have been described with respect to interaction between several components, modules and/or communication interfaces. It should be appreciated that such systems and components/modules/interfaces can include those components/modules or sub-modules specified therein, some of the specified components/modules or sub-modules, and/or additional modules. For example, a system could include serving cell 102 comprising interference mitigation apparatus 604, and UE 702 coupled with RQI apparatus 710, or a different combination of these or other entities. Sub-modules could also be implemented as modules communicatively coupled to other modules rather than included within parent modules. Additionally, it should be noted that one or more modules could be combined into a single module providing aggregate functionality. For instance, signal allocation module 612 can include transmission module 614, or vice versa, to facilitate instructing a UE to measure interference on a UE-specific pilot of another UE, and transmitting the instruction to the UE, by way of a single module. The modules can also interact with one or more other modules not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

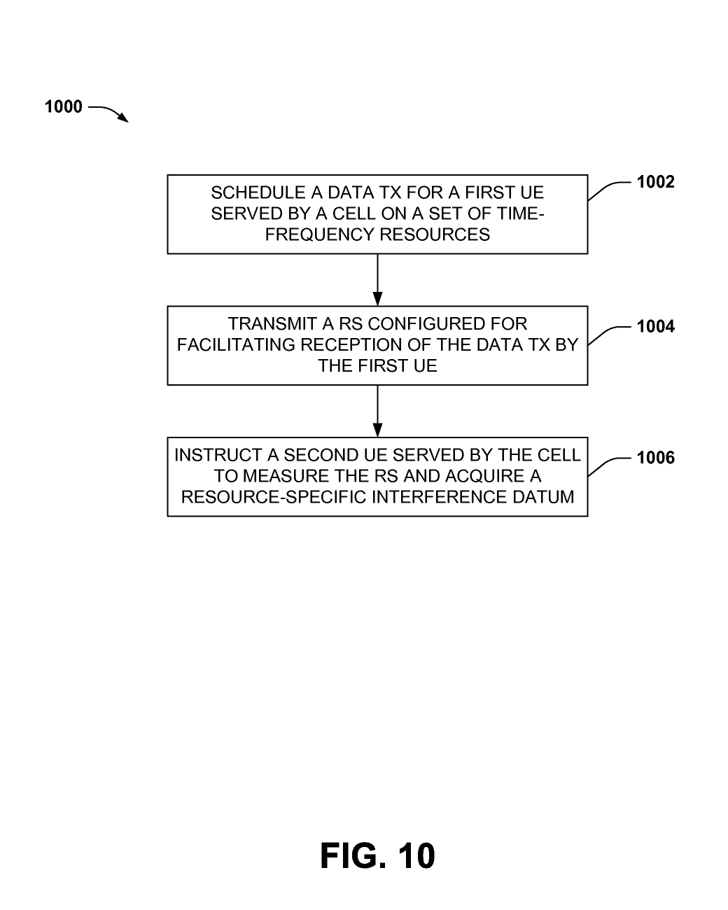

In view of the exemplary systems described supra, methodologies that may be implemented in accordance with the disclosed subject matter will be better appreciated with reference to the flow charts of FIGS. 10-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or storage medium.

FIG. 10 depicts a flowchart of an example methodology for providing interference mitigation in wireless communications. At 1002, method 1000 can comprise scheduling a data transmission for a first UE served by a cell of a wireless network on a set of time-frequency resources. Additionally, at 1004, method 1000 can comprise transmitting a RS configured at least in part for facilitating reception of the data transmission by the first UE. Moreover, at 1006, method 1000 can comprise instructing a second UE served by the cell to measure the RS and acquire a resource-specific metric of communication link quality for the set of time-frequency resources.

According to alternative aspects of the subject disclosure, method 1000 can additionally comprise identifying a set of uplink control resources for resource-specific interference reporting associated with the RS, and instructing the second UE to report the resource-specific metric of communication link quality on the set of uplink control resources. In one aspect, method 1000 can further comprise receiving the resource-specific metric of communication link quality from the second UE, and assigning the set of time-frequency resources to the second UE in a subsequent signal time frame. Additional aspects can comprise employing the resource-specific metric of communication link quality to generate a set of transmission parameters suitable to mitigate interference to the second UE in the subsequent signal time frame. In at least one aspect, method 1000 can additionally comprise transmitting a second data transmission to the second UE in the subsequent signal time frame according to the set of transmission parameters.

In yet other aspects of the subject disclosure, method 1000 can comprise employing for the RS a common RS that is shared by UEs operating within the cell. In one particular aspect, method 1000 can further comprise precoding, scrambling, power controlling or beamforming the RS, or a combination thereof, in a substantially similar manner as the data transmission. Further according to this aspect, method 1000 can comprise specifying the precoding, scrambling, power controlling or beamforming of the RS to the second UE in conjunction with instructing the second UE to measure the RS. Additionally according to this aspect, method 1000 can comprise at least one of specifying the set of time-frequency resources in conjunction with instructing the second UE to measure the RS if the RS is scrambled with a code that is known to the second UE, or is not scrambled; or specifying the set of time-frequency resources and a scrambling code specific to the second UE in conjunction with instructing the second UE to measure the RS if the RS is scrambled with the scrambling code specific to the second UE.

In still another aspect, initial CIR interference can be employed for interference mitigation. For instance, method 1000 can further comprise identifying a first CIR observed by the first UE and identifying a second CIR observed by the second UE. Moreover, method 1000 can comprise selecting the data transmission on the set of time-frequency resources for the first UE because the first CIR is above a target CIR or because the second CIR is below the target CIR. In at least one further aspect, method 1000 can also comprise configuring the RS at least in part with a beamforming parameter or a precoding parameter favorable for reception by the second UE if the first UE observes CIR levels above a target CIR or if the second UE observes CIR levels significantly below the target CIR.

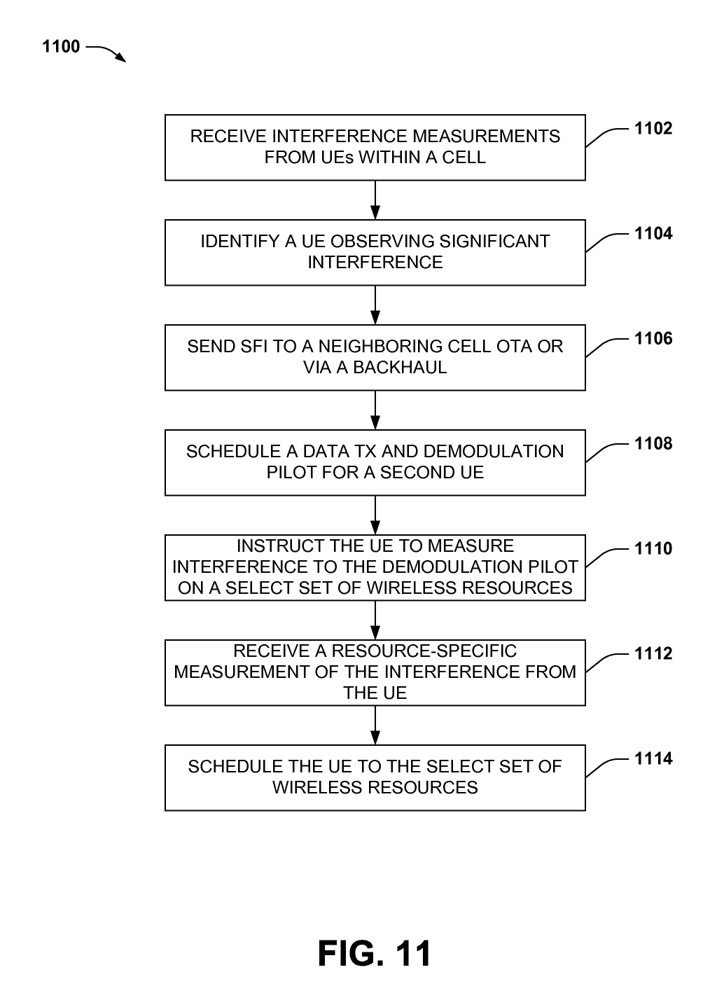

FIG. 11 illustrates a flowchart of a sample methodology 1100 for providing shared RS allocation for increasing efficiency in interference mitigation in wireless communications. At 1102, method 1100 can comprise receiving interference measurements from UEs within a cell of a wireless network. At 1104, method 1100 can comprise identifying a UE observing significant interference. At 1106, method 1100 can comprise sending an SFI-REQ to a neighboring cell. The SFI-REQ can be sent to the neighboring cell by a backhaul network, or over-the-air via the UE observing significant interference or one of the other UEs within the cell of the wireless network. At 1108, method 1100 can comprise scheduling a data transmission and DM-RS for a second UE. The second UE can be selected as a UE that observes moderate to low interference. In at least one aspect of the subject disclosure, the DM-RS can be configured with transmission parameters (e.g., a beamforming parameter, PSD, precoding parameter, or the like) suited to the second UE. In another aspect, the DM-RS can be configured with transmission parameters that are at least in part optimal for reception or demodulation at the UE observing significant interference. At 1110, method 1100 can comprise instructing the UE to measure interference to the DM-RS on a select set of wireless resources. At 1112, method 1100 can comprise receiving a resource-specific measurement of interference to the DM-RS from the UE. At 1114, method 1100 can comprise scheduling the UE to the select set of wireless resources.

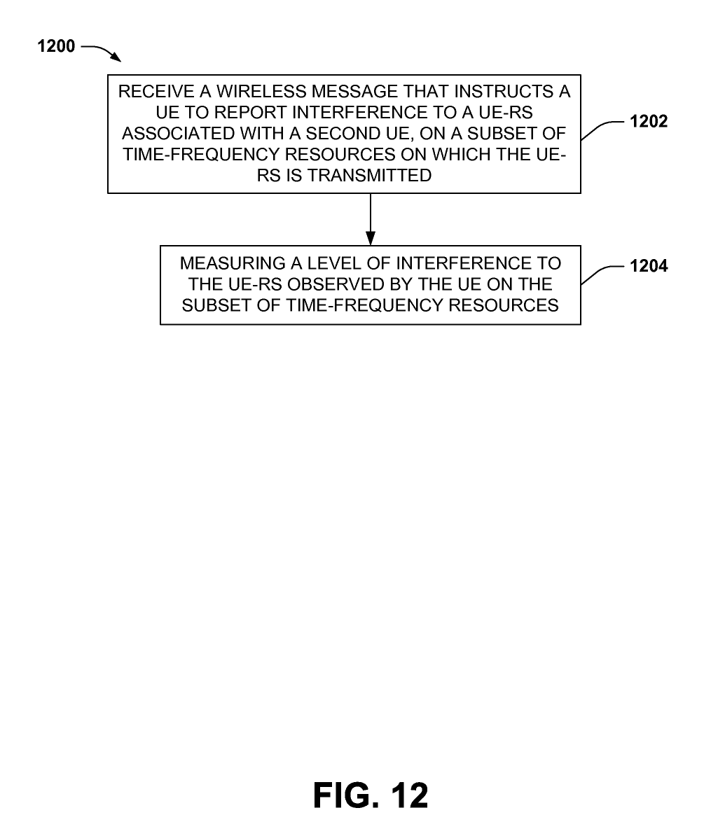

FIG. 12 depicts a flowchart of a sample methodology 1200 for facilitating improved interference mitigation in wireless communications. At 1202, method 1200 can comprise receiving a wireless message that instructs a UE to report interference to a UE-RS on a subset of time-frequency resources on which the UE-RS is transmitted. Particularly, the UE-RS can be configured at least in part for a data transmission scheduled for a second UE. In one aspect, method 1200 can additionally comprise receiving an instruction in conjunction with the wireless message that explicitly or implicitly identifies the subset of time-frequency resources, and provides information for properly identifying and receiving the UE-RS. At 1204, method 1200 can comprise measuring a level of interference to the UE-RS observed by the UE on the subset of time-frequency resources. Based on the level of interference, method 1200 can further comprise receiving an uplink or downlink assignment grant configured to mitigate interference to the UE on the subset of time-frequency resources in a subsequent time frame of wireless communication.

According to various alternative aspects of the subject disclosure, method 1200 can additionally comprise forwarding a channel quality metric derived from the level of interference to facilitate subsequent interference reduction on the subset of time-frequency resources. In other aspects, method 1200 can further comprise measuring the level of interference to the UE-RS for a duration of one subframe on the subset of time-frequency resources. And in yet an additional aspect, method 1200 can also comprise measuring the level of interference to the UE-RS for multiple subframes associated with the subset of time-frequency resources and forwarding a channel quality metric derived from the level of interference that reflects link quality for the UE-RS on a subframe-by-subframe basis.

In addition to the foregoing, method 1200 can alternatively comprise obtaining a scrambling parameter (e.g., a UE identifier, such as RNTI, of the second UE) in conjunction with the wireless message for decoding the UE-RS; or obtaining a cell-specific parameter from memory, or from higher layer network signaling, and employing the cell-specific scrambling parameter to decode or demodulate the UE-RS. In yet another alternative aspect, method 1200 can further comprise decoding a reference signal and a subsequent data transmission sent via unicast transmission to the UE on the subset of time-frequency resources in the subsequent time frame, measuring a second level of interference to the UE-RS observed on the subset of time-frequency resources for a duration of one or two subframes, and reporting the second level of interference to a serving cell with a time-based precision of substantially one subframe.

Based on modulation or scrambling protocols employed for the wireless communication, method 1200 can further comprise employing a PCI of a serving cell to descramble the UE-RS if the UE-RS is scrambled with the PCI, or alternatively receiving a UE-specific identifier of the second UE in conjunction with the wireless message and descrambling the UE-RS with the UE-specific identifier. In a particular aspect of the subject disclosure, the improved interference mitigation can include SFI reporting among one or more cells of a wireless network. Inter-cell communication supporting the SFI reporting can be conducted over a backhaul network, or over-the-air via one or more wireless terminals, or both. For instance, method 1200 can additionally comprise receiving an instruction to transmit SFI to an interfering cell. In at least one instance, the instruction to transmit SFI can be received prior to receiving the wireless message. Upon receiving the instruction to transmit SFI, method 1200 can comprise measuring a set of SFI with respect to a wireless channel between the interfering cell and the UE, and forwarding the set of SFI to the interfering cell, wherein the UE-RS is configured by a serving cell in accordance with an interference avoidance decision of the interfering cell that pertains to the UE.

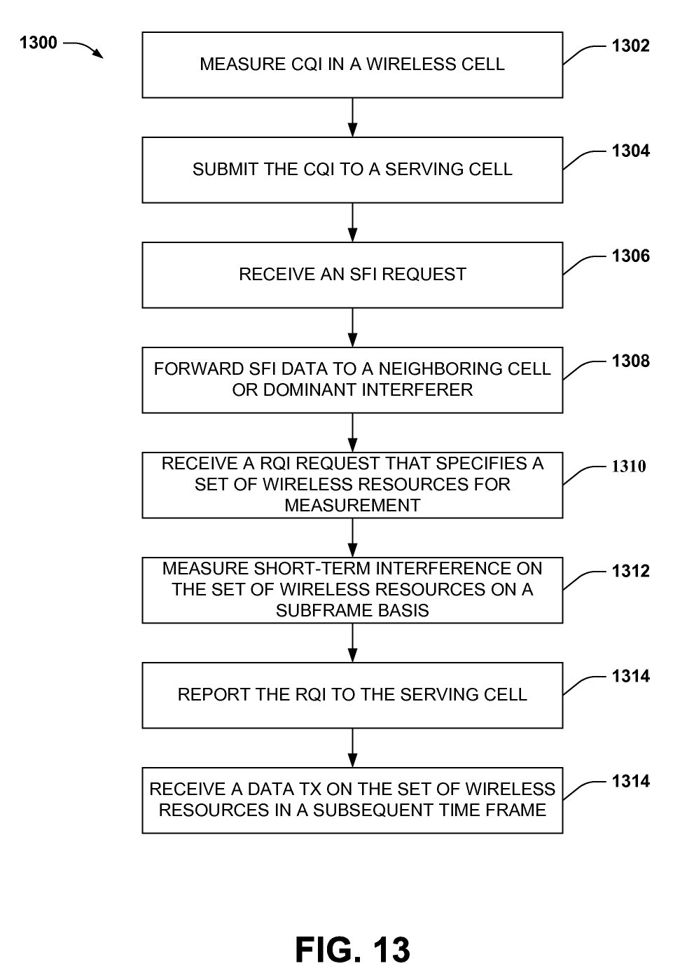

FIG. 13 illustrates a flowchart of a sample methodology 1300 for reporting short-term, resource-specific interference to mitigate or avoid interference caused by a dominant interferer. At 1302, method 1300 can comprise measuring CQI in a wireless cell. At 1304, method 1300 can comprise submitting a report of the CQI to a serving cell. At 1306, method 1300 can comprise receiving an SFI request. The SFI request can implicitly or explicitly specify an interfering transmitter to report SFI data in at least one aspect of the subject disclosure. At 1308, method 1300 can additionally comprise forwarding SFI data to a neighboring cell or dominant interferer. At 1310, method 1300 can comprise receiving an RQI-REQ that specifies a set of wireless resources for an interference measurement. At 1312, method 1300 can comprise measuring short-term interference on the set of wireless resources. According to a particular aspect, the interference can be measured with a granularity of one or two subframes or less. At 1314, method 1300 can comprise reporting an RQI comprising a result of the short-term interference on the set of wireless resources to the serving cell. At 1316, method 1300 can comprise receiving a data transmission on the set of wireless resources in a subsequent time frame of wireless communication.

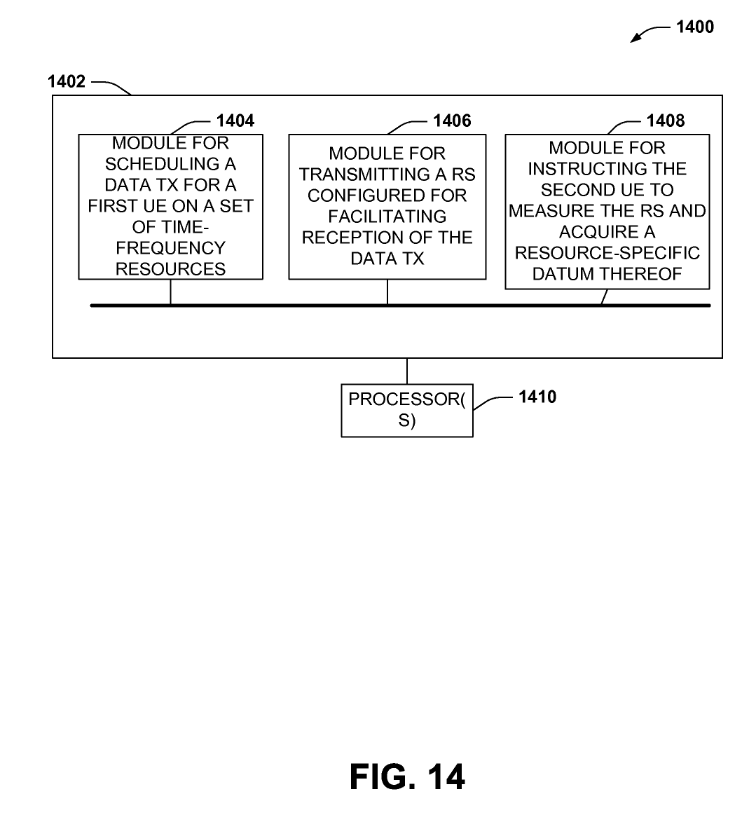

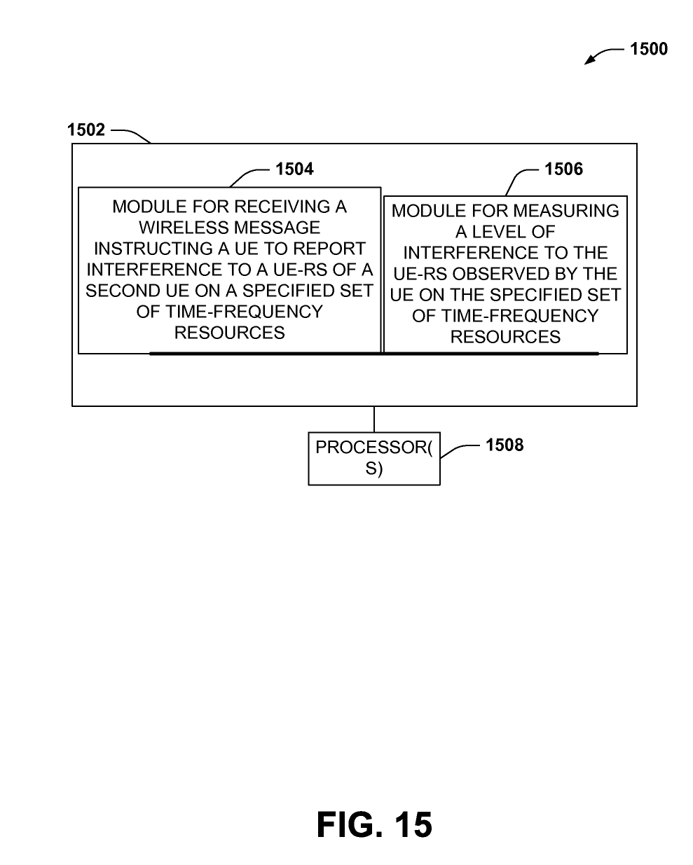

FIGS. 14 and 15 illustrate respective example apparatuses 1400, 1500 for implementing improved acknowledgment and re-transmission protocols for wireless communication according to aspects of the subject disclosure. For instance, apparatuses 1400, 1500 can reside at least partially within a wireless communication network and/or within a wireless receiver such as a node, base station, access point, user terminal, personal computer coupled with a mobile interface card, or the like. It is to be appreciated that apparatuses 1400, 1500 are represented as including functional blocks, which can be functional blocks that represent functions implemented by a processor, software, or combination thereof (e.g., firmware).

Apparatus 1400 can comprise memory 1402 for storing modules or instructions configured to execute functions of apparatus 1400, including implementing shared resource-specific or UE-specific RSs for interference mitigation in wireless communication, and a data processor 1410 for executing modules for implementing these functions. Particularly, apparatus 1400 can comprise a module 1404 for scheduling a data transmission for a first UE served by a cell of a wireless network on a set of time-frequency resources. In one aspect, the first UE can be selected as a UE observing moderate to low interference. Additionally, apparatus 1400 can comprise a module 1406 for transmitting a RS configured at least in part for facilitating reception of the data transmission by the first UE. In one example, module 1406 configures the RS with transmission parameters suitable for reception by the first UE. In another example, however, module 1406 could instead configured the RS with transmission parameters at least in part preferable for reception by a second UE served by the cell (e.g., a UE observing significant interference). Further to the above, apparatus 1400 can also comprise a module 1408 for instructing the second UE served by the cell to measure the RS and acquire a resource-specific metric of communication link quality for the set of time-frequency resources. This resource-specific metric of communication link quality can be utilized to determine appropriate transmission parameters for transmissions to the second UE, for instance by selecting an appropriate data rate, MCS, or the like, given the resource-specific interference.

Apparatus 1500 can comprise a memory 1502 for storing modules or instructions configured to execute functions of apparatus 1500, including employing RQI reporting for improved wireless communications, and a data processor 1508 for executing modules to implement those functions. Apparatus 1500 includes a first module 1504 for receiving a wireless message instructing a UE to report interference to a UE-RS of a second UE on a specified set of time-frequency resources. Further, apparatus 1500 can include a second module 1506 for measuring a level of interference to the UE-RS observed by the UE on the specified set of time-frequency resources. Measured data can be reported to a serving cell of a wireless network, to facilitate transmission parameterization that accounts for the interference on the set of time-frequency resources.

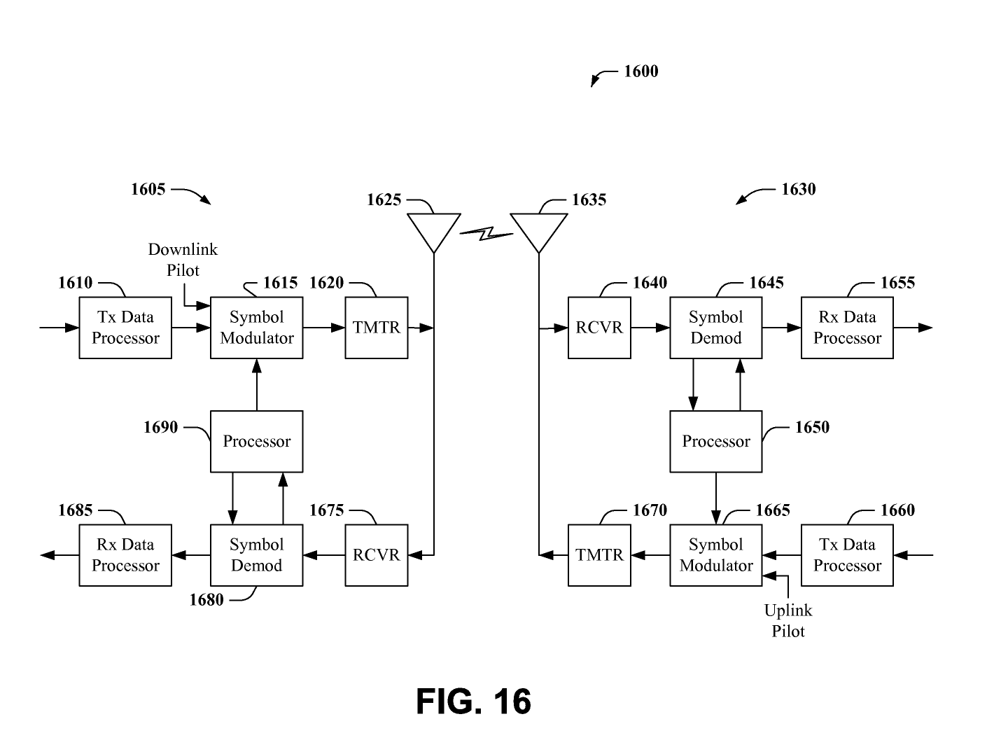

FIG. 16 depicts a block diagram of an example system 1600 that can facilitate wireless communication according to some aspects disclosed herein. On a DL, at access point 1605, a transmit (TX) data processor 1610 receives, formats, codes, interleaves, and modulates (or symbol maps) traffic data and provides modulation symbols (“data symbols”). A symbol modulator 1615 receives and processes the data symbols and pilot symbols and provides a stream of symbols. A symbol modulator 1615 multiplexes data and pilot symbols and provides them to a transmitter unit (TMTR) 1620. Each transmit symbol can be a data symbol, a pilot symbol, or a signal value of zero. The pilot symbols can be sent continuously in each symbol period. The pilot symbols can be frequency division multiplexed (FDM), orthogonal frequency division multiplexed (OFDM), time division multiplexed (TDM), code division multiplexed (CDM), or a suitable combination thereof or of like modulation and/or transmission techniques.

TMTR 1620 receives and converts the stream of symbols into one or more analog signals and further conditions (e.g., amplifies, filters, and frequency upconverts) the analog signals to generate a DL signal suitable for transmission over the wireless channel. The DL signal is then transmitted through an antenna 1625 to the terminals. At terminal 1630, an antenna 1635 receives the DL signal and provides a received signal to a receiver unit (RCVR) 1640. Receiver unit 1640 conditions (e.g., filters, amplifies, and frequency downconverts) the received signal and digitizes the conditioned signal to obtain samples. A symbol demodulator 1645 demodulates and provides received pilot symbols to a processor 1650 for channel estimation. Symbol demodulator 1645 further receives a frequency response estimate for the DL from processor 1650, performs data demodulation on the received data symbols to obtain data symbol estimates (which are estimates of the transmitted data symbols), and provides the data symbol estimates to an RX data processor 1655, which demodulates (i.e., symbol demaps), deinterleaves, and decodes the data symbol estimates to recover the transmitted traffic data. The processing by symbol demodulator 1645 and RX data processor 1655 is complementary to the processing by symbol modulator 1615 and TX data processor 1610, respectively, at access point 1605.

On the UL, a TX data processor 1660 processes traffic data and provides data symbols. A symbol modulator 1665 receives and multiplexes the data symbols with pilot symbols, performs modulation, and provides a stream of symbols. A transmitter unit 1670 then receives and processes the stream of symbols to generate an UL signal, which is transmitted by the antenna 1635 to the access point 1605. Specifically, the UL signal can be in accordance with SC-FDMA requirements and can include frequency hopping mechanisms as described herein.

At access point 1605, the UL signal from terminal 1630 is received by the antenna 1625 and processed by a receiver unit 1675 to obtain samples. A symbol demodulator 1680 then processes the samples and provides received pilot symbols and data symbol estimates for the UL. An RX data processor 1685 processes the data symbol estimates to recover the traffic data transmitted by terminal 1630. A processor 1690 performs channel estimation for each active terminal transmitting on the UL. Multiple terminals can transmit pilot concurrently on the UL on their respective assigned sets of pilot sub-bands, where the pilot sub-band sets can be interlaced.

Processors 1690 and 1650 direct (e.g., control, coordinate, manage, etc.) operation at access point 1605 and terminal 1630, respectively. Respective processors 1690 and 1650 can be associated with memory units (not shown) that store program codes and data. Processors 1690 and 1650 can also perform computations to derive frequency and time-based impulse response estimates for the UL and DL, respectively.

For a multiple-access system (e.g., SC-FDMA, FDMA, OFDMA, CDMA, TDMA, etc.), multiple terminals can transmit concurrently on the UL. For such a system, the pilot sub-bands can be shared among different terminals. The channel estimation techniques can be used in cases where the pilot sub-bands for each terminal span the entire operating band (possibly except for the band edges). Such a pilot sub-band structure would be desirable to obtain frequency diversity for each terminal.

The techniques described herein can be implemented by various means. For example, these techniques can be implemented in hardware, software, or a combination thereof. For a hardware implementation, which can be digital, analog, or both digital and analog, the processing units used for channel estimation can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes can be stored in memory unit and executed by the processors 1690 and 1650.

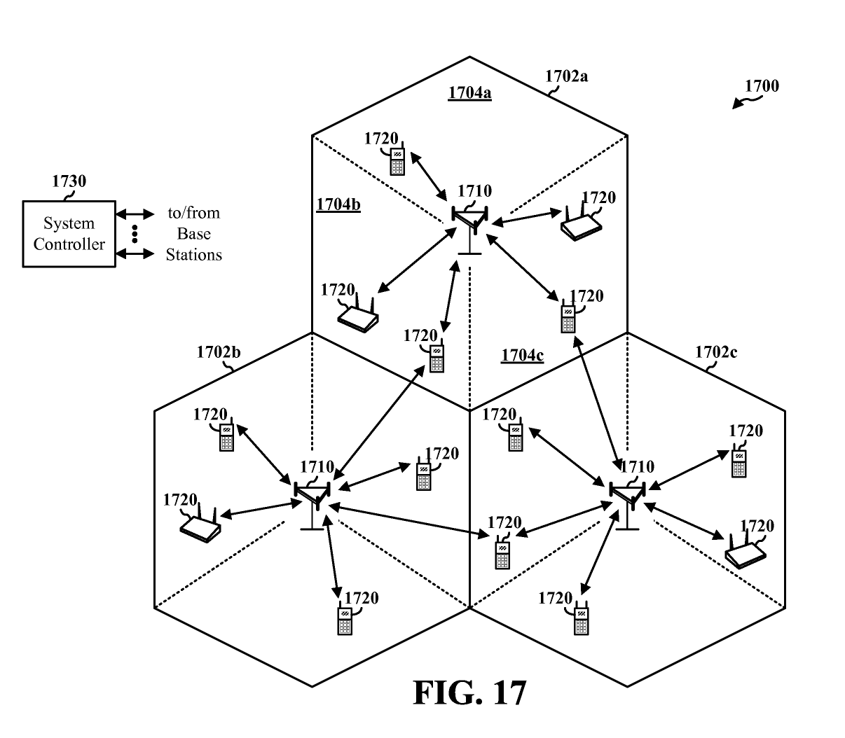

FIG. 17 illustrates a wireless communication system 1700 with multiple base stations (BSs) 1710 (e.g., wireless access points, wireless communication apparatus) and multiple terminals 1720 (e.g., ATs), such as can be utilized in conjunction with one or more aspects. A BS 1710 is generally a fixed station that communicates with the terminals and can also be called an access point, a Node B, or some other terminology. Each BS 1710 provides communication coverage for a particular geographic area or coverage area, illustrated as three geographic areas in FIG. 17, labeled 1702a, 1702b, and 1702c. The term “cell” can refer to a BS or its coverage area depending on the context in which the term is used. To improve system capacity, a BS geographic area/coverage area can be partitioned into multiple smaller areas (e.g., three smaller areas, according to cell 1702a in FIG. 17), 1704a, 1704b, and 1704c. Each smaller area (1704a, 1704b, 1704c) can be served by a respective base transceiver subsystem (BTS). The term “sector” can refer to a BTS or its coverage area depending on the context in which the term is used. For a sectorized cell, the BTSs for all sectors of that cell are typically co-located within the base station for the cell. The transmission techniques described herein can be used for a system with sectorized cells as well as a system with un-sectorized cells. For simplicity, in the subject description, unless specified otherwise, the term “base station” is used generically for a fixed station that serves a sector as well as a fixed station that serves a cell.

Terminals 1720 are typically dispersed throughout the system, and each terminal 1720 can be fixed or mobile. Terminals 1720 can also be called a mobile station, user equipment, a user device, wireless communication apparatus, an access terminal, a user terminal or some other terminology. A terminal 1720 can be a wireless device, a cellular phone, a personal digital assistant (PDA), a wireless modem card, and so on. Each terminal 1720 can communicate with zero, one, or multiple BSs 1710 on the downlink (e.g., FL) and uplink (e.g., RL) at any given moment. The downlink refers to the communication link from the base stations to the terminals, and the uplink refers to the communication link from the terminals to the base stations.

For a centralized architecture, a system controller 1730 couples to base stations 1710 and provides coordination and control for BSs 1710. For a distributed architecture, BSs 1710 can communicate with one another as needed (e.g., by way of a wired or wireless backhaul network communicatively coupling the BSs 1710). Data transmission on the forward link often occurs from one access point to one access terminal at or near the maximum data rate that can be supported by the forward link or the communication system. Additional channels of the forward link (e.g., control channel) can be transmitted from multiple access points to one access terminal. Reverse link data communication can occur from one access terminal to one or more access points.

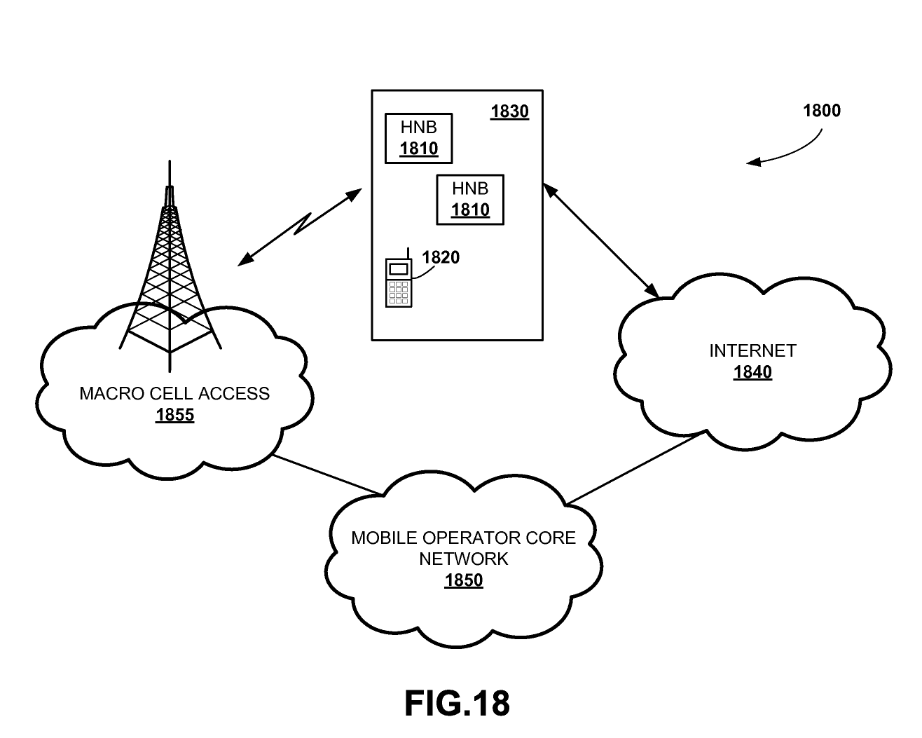

FIG. 18 illustrates an exemplary communication system to enable deployment of access point base stations within a network environment. As shown in FIG. 18, the system 1800 includes multiple access point base stations or Home Node B units (HNBs) or Femto cells, such as, for example, HNBs 1810, each being installed in a corresponding small scale network environment, such as, for example, in one or more user residences 1830, and being configured to serve associated, as well as alien, user equipment (UE) 1820. Each HNB 1810 is further coupled to the Internet 1840 and a mobile operator core network 1850 via a DSL router (not shown) or, alternatively, a cable modem (not shown).

Although embodiments described herein use 3GPP terminology, it is to be understood that the embodiments may be applied to 3GPP (Rel99, Rel5, Rel6, Rel7) technology, as well as 3GPP2 (1xRTT, 1xEV-DO Rel0, RevA, RevB) technology and other known and related technologies. In such embodiments described herein, the owner of the HNB 1810 subscribes to mobile service, such as, for example, 3G mobile service, offered through the mobile operator core network 1850, and the UE 1820 is capable to operate both in macro cellular environment and in residential small scale network environment. Thus, the HNB 1810 is backward compatible with any existing UE 1820.

Furthermore, in addition to the mobile operator core network 1850, the UE 1820 can only be served by a predetermined number of HNBs 1810, namely the HNBs 1810 that reside within the user's residence 1830, and cannot be in a soft handover state with the mobile operator core network 1850. The UE 1820 can communicate with either the mobile operator core network 1850 via a macro cell access 1855 or with the HNBs 1810, but not both simultaneously. As long as the UE 1820 is authorized to communicate with the HNB 1810, within the user's residence it is desired that the UE 1820 communicate only with the associated HNBs 1810.

As used in the subject disclosure, the terms “component,” “system,” “module” and the like are intended to refer to a computer-related entity, either hardware, software, software in execution, firmware, middle ware, microcode, and/or any combination thereof. For example, a module can be, but is not limited to being, a process running on a processor, a processor, an object, an executable, a thread of execution, a program, a device, and/or a computer. One or more modules can reside within a process, or thread of execution; and a module can be localized on one electronic device, or distributed between two or more electronic devices. Further, these modules can execute from various computer-readable media having various data structures stored thereon. The modules can communicate by way of local or remote processes such as in accordance with a signal having one or more data packets (e.g., data from one component interacting with another component in a local system, distributed system, or across a network such as the Internet with other systems by way of the signal). Additionally, components or modules of systems described herein can be rearranged, or complemented by additional components/modules/systems in order to facilitate achieving the various aspects, goals, advantages, etc., described with regard thereto, and are not limited to the precise configurations set forth in a given figure, as will be appreciated by one skilled in the art.

Furthermore, various aspects are described herein in connection with a UE. A UE can also be called a system, a subscriber unit, a subscriber station, mobile station, mobile, mobile communication device, mobile device, remote station, remote terminal, AT, user agent (UA), a user device, or user terminal (UE). A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In one or more exemplary embodiments, the functions described can be implemented in hardware, software, firmware, middleware, microcode, or any suitable combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media may be any physical media that can be accessed by a computer. By way of example, and not limitation, such computer storage media can comprise RAM, ROM, EEPROM, CD-ROM or other optical disk storage, magnetic disk storage or other magnetic storage devices, smart cards, and flash memory devices (e.g., card, stick, key drive . . . ), or any other medium that can be used to carry or store desired program code in the form of instructions or data structures and that can be accessed by a computer. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, the processing units' various illustrative logics, logical blocks, modules, and circuits described in connection with the aspects disclosed herein can be implemented or performed within one or more ASICs, DSPs, DSPDs, PLDs, FPGAs, discrete gate or transistor logic, discrete hardware components, general purpose processors, controllers, micro-controllers, microprocessors, other electronic units designed to perform the functions described herein, or a combination thereof. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the steps and/or actions described herein.

Moreover, various aspects or features described herein can be implemented as a method, apparatus, or article of manufacture using standard programming and/or engineering techniques. Further, the steps and/or actions of a method or algorithm described in connection with the aspects disclosed herein can be embodied directly in hardware, in a software module executed by a processor, or in a combination of the two. Additionally, in some aspects, the steps or actions of a method or algorithm can reside as at least one or any combination or set of codes or instructions on a machine-readable medium, or computer-readable medium, which can be incorporated into a computer program product.

Additionally, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, as used herein, the terms to “infer” or “inference” refer generally to the process of reasoning about or inferring states of the system, environment, or user from a set of observations as captured via events, or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events, or data. Such inference results in the construction of new events or actions from a set of observed events and/or stored event data, whether or not the events are correlated in close temporal proximity, and whether the events and data come from one or several event and data sources.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A method for wireless communication, comprising:
scheduling a data transmission for a first user equipment (a first UE) served by a cell of a wireless network on a set of time-frequency resources;
transmitting a reference signal (a RS) configured at least in part for facilitating reception of the data transmission by the first UE; and
instructing a second UE served by the cell to measure the RS and acquire a resource-specific metric of communication link quality for the set of time-frequency resources.

2. The method of claim 1, further comprising identifying a set of uplink control resources for resource-specific interference reporting associated with the RS, and instructing the second UE to report the resource-specific metric on the set of uplink control resources.

3. The method of claim 1, further comprising receiving the resource-specific metric from the second UE, and assigning the set of time-frequency resources to the second UE in a subsequent signal time frame.

4. The method of claim 1, further comprising employing the resource-specific metric to at least one of:
generate a set of transmission parameters suitable to mitigate interference to the second UE in a subsequent signal time frame; or
select a set of downlink wireless resources at least in part different from the set of time-frequency resources for a subsequent data transmission to the second UE.

5. The method of claim 4, further comprising transmitting a second data transmission to the second UE in the subsequent signal time frame according to the set of transmission parameters or the set of downlink wireless resources.

6. The method of claim 1, further comprising employing for the RS a common RS that is shared by UEs operating within the cell.

7. The method of claim 1, further comprising employing for the RS a UE-specific RS that is specific to the first UE.

8. The method of claim 7, further comprising specifying a precoding, scrambling, power control or beamforming parameter of the UE-specific RS to the second UE in conjunction with instructing the second UE to measure the RS.

9. The method of claim 8, further comprising at least one of:
specifying the set of time-frequency resources in conjunction with instructing the second UE to measure the RS if the RS is scrambled with a code that is known to the second UE, or is not scrambled; or
specifying the set of time-frequency resources and a scrambling code specific to the second UE in conjunction with instructing the second UE to measure the RS if the RS is scrambled with the scrambling code specific to the first UE.

10. The method of claim 1, further comprising:
identifying a first carrier to interference ratio (a first CIR) observed by the first UE and identifying a second CIR observed by the second UE, and
selecting the data transmission on the set of time-frequency resources for the first UE because the first CIR is above a target CIR or because the second CIR is below the target CIR.

11. The method of claim 1, further comprising configuring the RS at least in part with a beamforming parameter or a precoding parameter favorable for reception by the second UE if the first UE observes CIR levels above a target CIR or if the second UE observes CIR levels significantly below the target CIR.

12. An apparatus for wireless communication, comprising:
a memory for storing instructions configured to provide shared reference signal (RS) allocation for interference mitigation in wireless communication; and
a processor that executes modules for implementing the instructions, the modules comprising:
an signal allocation module that identifies a data transmission scheduled for a first user equipment (a first UE) served by the apparatus and that generates an instruction for a second UE to measure a channel quality metric with respect to a pilot signal associated with the data transmission on a specified set of wireless resources; and
a transmission module that sends a wireless message comprising the instruction to the second UE.

13. The apparatus of claim 12, wherein the pilot signal is configured with a similar beamforming parameter, precoding parameter or power control parameter as the data transmission, and further wherein the pilot signal comprises signal energy at least on the specified set of wireless resources.

14. The apparatus of claim 12, wherein the pilot signal is a UE-specific demodulation signal transmitted in conjunction with the data transmission and configured at least in part to assist the first UE in demodulating the data transmission.

15. The apparatus of claim 12, wherein at least one of:
the pilot signal is a common pilot employed by a wireless cell associated with the apparatus that comprises signal energy on a superset of wireless resources of which the specified set of wireless resources is a subset;
the pilot signal is a UE-specific demodulation signal that is scrambled with an identifier of the wireless cell that is known to the second UE; or
the pilot signal is a UE-specific demodulation signal scrambled with an identifier of the first UE, and further wherein the wireless message specifies the identifier of the first UE to enable the second UE to descramble the pilot signal.

16. The apparatus of claim 12, further comprising:
a receiving module that obtains a resource-specific channel quality report from the second UE; and
a scheduling module that provides an uplink transmission grant or downlink transmission grant to the second UE at least in part based on the resource-specific channel quality report.

17. The apparatus of claim 12, further comprising an inter-cell interference cancellation module (an ICIC module) that forwards a spatial feedback information report (a SFI report) to an interfering cell; wherein the SFI report includes a measurement of interference caused by the interfering cell to one or more UEs served by the apparatus.

18. The apparatus of claim 17, wherein interference to the pilot signal measured by the second UE on the specified set of wireless resources includes beamforming or power reduction configured by the interfering cell to reduce interference to the second UE on the specified set of wireless resources.

19. The apparatus of claim 12, further comprising an interference analysis module that requests the first UE and the second UE to measure respective carrier to interference levels (CIR levels) observed by the first UE and the second UE, and to transmit respective CIR reports to the apparatus.

20. The apparatus of claim 19, further comprising a cell selection module that schedules the data transmission for the first UE on the specified set of wireless resources at least in part because a first CIR level measured by the first UE is above a target CIR level, or because a second CIR level measured by the second UE is below the target CIR level.

21. The apparatus of claim 20, wherein the cell selection module schedules the data transmission for the first UE on the specified set of wireless resources based additionally on a fairness constraint or on a long-term projected scheduling utility for the first UE or the second UE.

22. The apparatus of claim 20, wherein the transmission module configures the pilot signal with a beamforming parameter or a precoding parameter optimized for reception of the pilot signal by the second UE, based on the first CIR level, the second CIR level, or a ratio of the first CIR level and the second CIR level.

23. An apparatus for wireless communication, comprising:
means for scheduling a data transmission for a first user equipment (a first UE) served by a cell of a wireless network on a set of time-frequency resources;
means for transmitting a reference signal (a RS) configured at least in part for facilitating reception of the data transmission by the first UE; and
means for instructing a second UE served by the cell to measure the RS and acquire a resource-specific metric of communication link quality for the set of time-frequency resources.

24. At least one processor configured for wireless communication, comprising:
a first module that schedules a data transmission for a first user equipment (a first UE) served by a cell of a wireless network on a set of time-frequency resources;
a second module that transmits a reference signal (a RS) configured at least in part for facilitating reception of the data transmission by the first UE; and
a third module that instructs a second UE served by the cell to measure the RS and acquire a resource-specific metric of communication link quality for the set of time-frequency resources.

25. A computer program product, comprising:
a computer-readable medium, comprising:
a first set of codes for causing a computer to schedule a data transmission for a first user equipment (a first UE) served by a cell of a wireless network on a set of time-frequency resources;
a second set of codes for causing the computer to transmit a reference signal (a RS) configured at least in part for facilitating reception of the data transmission by the first UE; and
a third set of codes for causing the computer to send an instruction to a second UE served by the cell to measure the RS and acquire a resource-specific metric of communication link quality for the set of time-frequency resources.

26. A method for wireless communication, comprising:
receiving a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE; and
measuring a level of interference to the UE-RS observed by the UE on the subset of time-frequency resources.

27. The method of claim 26, further comprising forwarding a channel quality metric derived from the level of interference to facilitate subsequent interference reduction on the subset of time-frequency resources.

28. The method of claim 26, further comprising measuring the level of interference to the UE-RS for a duration of one subframe on the subset of time-frequency resources.

29. The method of claim 26, further comprising measuring the level of interference to the UE-RS for multiple subframes associated with the subset of time-frequency resources and forwarding a channel quality metric derived from the level of interference that reflects link quality for the UE-RS on a subframe-by-subframe basis.

30. The method of claim 26, further comprising at least one of:
obtaining a scrambling parameter for decoding the UE-RS in conjunction with the wireless message; or
obtaining a cell-specific scrambling parameter from memory, or from higher layer network signaling, and employing the cell-specific scrambling parameter to decode or demodulate the UE-RS.

31. The method of claim 26, further comprising receiving an uplink or downlink assignment grant configured to mitigate interference to the UE on the subset of time-frequency resources in a subsequent time frame of wireless communication.

32. The method of claim 31, further comprising:
decoding a reference signal and a subsequent data transmission sent via unicast transmission to the UE on the subset of time-frequency resources in the subsequent time frame;
measuring a second level of interference to the UE-RS observed on the subset of time-frequency resources for a duration of one or two subframes; and
reporting the second level of interference to a serving cell with a time-based precision of substantially one subframe.

33. The method of claim 26, further comprising employing a physical cell identifier (a PCI) of a serving cell to descramble the UE-RS if the UE-RS is scrambled with the PCI.

34. The method of claim 26, further comprising receiving a UE-specific identifier of the second UE in conjunction with the wireless message and descrambling the UE-RS with the UE-specific identifier.

35. The method of claim 26, further comprising:
receiving an instruction to transmit spatial feedback information (SFI) to an interfering cell;
measuring a set of SFI with respect to a wireless channel between the interfering cell and the UE; and
forwarding the set of SFI to the interfering cell, wherein the UE-RS, or a subsequent data transmission scheduled for the UE, is configured by a serving cell at least in part in accordance with an interference avoidance decision of the interfering cell that pertains to the UE.

36. The method of claim 26, further comprising receiving an instruction in conjunction with the wireless message that explicitly or implicitly identifies the subset of time-frequency resources, and provides information for properly identifying and receiving the UE-RS.

37. An apparatus configured for wireless communication, comprising:
a memory for storing instructions configured to provide short-term resource-specific interference reporting for wireless communication; and
a data processor for executing modules to implement the instructions, the modules comprising:
a decoding module that identifies a wireless message within a downlink transmission instructing a user equipment (a UE) associated with the apparatus to measure resource-specific interference to a pilot signal transmitted by a serving cell; and
an analysis module that acquires information for identifying and decoding the pilot signal from the wireless message, and measures the resource-specific interference to the pilot signal with a time-based precision of substantially one subframe.

38. The apparatus of claim 37, wherein the pilot signal is a common pilot employed by the serving cell, and the analysis module employs a cell-wide identifier to decode and receive the pilot signal.

39. The apparatus of claim 37, wherein the pilot signal is a UE-specific pilot signal (a UE pilot) configured at least in part for a second UE associated with the serving cell.

40. The apparatus of claim 39, wherein the UE pilot is a UE demodulation reference signal (a UE DM-RS) associated with a data transmission that targets the second UE.

41. The apparatus of claim 40, wherein the wireless message specifies a precoding parameter, a beamforming parameter or a scrambling code required to decode the UE DM-RS.

42. The apparatus of claim 37, wherein the pilot signal is a UE pilot that comprises a beamforming parameter or a precoding parameter favorable to the UE.

43. The apparatus of claim 37, wherein the wireless message explicitly or implicitly identifies a set of time-frequency resources for a measurement of resource-specific interference to the pilot signal.

44. The apparatus of claim 37, further comprising a reporting module that forwards a channel quality parameter derived from the resource-specific interference to the serving cell, wherein the channel quality parameter is utilized by the serving cell to improve a carrier to interference ratio (a CIR) observed by the apparatus on a set of time-frequency resources.

45. The apparatus of claim 37, further comprising a spatial interference module that:
employs the decoding module to receive an instruction to provide a spatial feedback report (a SFI report) to a dominant interferer;
employs the analysis module to measure quality of a wireless channel between the dominant interferer and the UE; and
forwards the SFI report comprising a channel quality indicator of the wireless channel either over-the-air directly to the dominant interferer, or indirectly via the serving cell.

46. The apparatus of claim 37, wherein the wireless message is in a downlink control information format and the downlink transmission is conveyed on a physical downlink control channel.

47. The apparatus of claim 37, wherein the analysis module transmits a non-resource specific measure of interference to the serving cell that triggers resource-specific interference protocols to mitigate a high level of interference observed at the UE.

48. An apparatus for wireless communication, comprising:
means for receiving a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE; and
means for measuring a level of interference to the UE-RS observed by the UE on the subset of time-frequency resources.

49. At least one processor configured for wireless communication, comprising:
a first module that receives a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE; and
a second module that measures a level of interference to the UE-RS observed by the UE on the subset of time-frequency resources.

50. A computer program product, comprising:
a computer-readable medium, comprising:
a first set of codes for causing a computer to receive a wireless message that instructs a user equipment (a UE) to report interference to a UE-specific reference signal (a UE-RS) on a subset of time-frequency resources on which the UE-RS is transmitted, wherein the UE-RS is configured at least in part for a data transmission scheduled for a second UE; and
a second set of codes for causing the computer to measure a level of interference to the UE-RS observed by the UE on the subset of time-frequency resources.
